(19) United States
(12) Patent Application Publication
(10) Pub. No.: US 2024/0406168 A1
(43) Pub. Date: Dec. 5, 2024

(54) AUTHENTICATION APPARATUS, AUTHENTICATION SYSTEM, AUTHENTICATION METHOD, AND NON-TRANSITORY COMPUTER-READABLE MEDIUM

(71) Applicant: NEC Corporation, Minato-ku, Tokyo (JP)

(72) Inventor: Tadanobu NAKAYAMA, Tokyo (JP)

(73) Assignee: NEC Corporation, Minato-ku, Tokyo (JP)

(21) Appl. No.: 18/698,453

(22) PCT Filed: Oct. 27, 2021
(86) PCT No.: PCT/JP2021/039693

§ 371 Date: Apr. 4, 2024

(51) Int. Cl. H04L 9/40

(52) U.S. Cl. CPC H04L 63/0861

(57) ABSTRACT

Provided is an authentication apparatus capable of appropriately performing personal authentication. An authentication apparatus (40) according to the present disclosure includes: an acquisition unit (41) configured to acquire authentication information that is second biometric information of a user who has succeeded in biometric authentication using first biometric information, and is second biometric information capable of being acquired by an instrument that has acquired the first biometric information; a comparison unit (43) configured to compare collation information registered in advance with the authentication information; and an authentication unit (44) configured to perform personal authentication of the user on the basis of a result of the comparison.

### TECHNICAL FIELD

The present disclosure relates to an authentication apparatus, an authentication system, an authentication method, and a non-transitory computer-readable medium.

### BACKGROUND ART

There is known a technology of performing biometric authentication using biometric information such as a face and a voiceprint for personal authentication of a user. As a related technology, Patent Literature 1 discloses a call control apparatus that transmits and receives voice data between a calling party and a called party through a network. The call control apparatus includes a voice information processing unit that extracts a voiceprint uttered by the calling party and collates the extracted voiceprint with voiceprint information stored in advance before establishing a call connection between the calling party and the called party when detecting an incoming call. In addition, the call control apparatus further includes a control unit that determines whether or not to call the called party in correspondence with a result of the collation performed by the voice information processing unit.

### CITATION LIST

### Patent Literature

Patent Literature 1: Japanese Unexamined Patent Application Publication No. 2020-048056

### SUMMARY OF INVENTION

### Technical Problem

In the biometric authentication, there is a case where false authentication occurs. For example, rejection of the user himself/herself for determining that an authentication target is not the user himself/herself even though the authentication target is the user himself/herself, or acceptance of another person for determining that the authentication target is the user himself/herself even though the authentication target is a person other than the user may occur. In the call control apparatus disclosed in Patent Literature 1 described above, when the extracted voiceprint does not match an incoming call permission list or an incoming call rejection list, the control unit determines to ask the calling party a pre-registered secret question about the called party. In addition, the control unit determines whether or not to make a call in response to the answer of the calling party to the secret question. Examples of the secret question include a date of birth of the called party, a nickname of the called party, and the like.

In addition to the biometric authentication, it is conceivable to avoid rejection of the person in question and acceptance of another person and to improve accuracy of personal authentication by correctly answering the secret question. However, in a case where a person to be authenticated is asked to answer the secret question such as the date of birth or the nickname as in the technology disclosed in Patent Literature 1, there is a possibility that a person other than the person in question may answer the question correctly.

In view of the above-described problems, an object of the present disclosure is to provide an authentication apparatus, an authentication system, an authentication method, and a program capable of appropriately performing personal authentication.

### Solution to Problem

According to an aspect of the present disclosure, there is provided an authentication apparatus including:
acquisition means for acquiring authentication information that is second biometric information of a user who has succeeded in biometric authentication using first biometric information, and is second biometric information capable of being acquired by an instrument that has acquired the first biometric information;
comparison means for comparing collation information registered in advance with the authentication information; and
authentication means for performing personal authentication of the user on the basis of a result of the comparison.

According to another aspect of the present disclosure, there is provided an authentication system including:
an authentication terminal configured to acquire first biometric information of a user and control biometric authentication of the user; and
an authentication apparatus connected to the authentication terminal,
wherein the authentication apparatus includes,
acquisition means for acquiring authentication information that is second biometric information of the user who has succeeded in the biometric authentication and is second biometric information capable of being acquired by the authentication terminal,
comparison means for comparing collation information registered in advance with the authentication information, and
authentication means for performing personal authentication of the user on the basis of a result of the comparison.

According to still another aspect of the present disclosure, there is provided an authentication method including:
acquiring authentication information that is second biometric information of a user who has succeeded in biometric authentication using first biometric information, and is second biometric information capable of being acquired by an instrument that has acquired the first biometric information;
comparing collation information registered in advance with the authentication information; and
performing personal authentication of the user on the basis of a result of the comparison.

According to still another aspect of the present disclosure, there is provided a non-transitory computer-readable medium that stores a program causing a computer to execute:
acquisition processing of acquiring authentication information that is second biometric information of a user who has succeeded in biometric authentication using first biometric information, and is second biometric information capable of being acquired by an instrument that has acquired the first biometric information;
comparison processing of comparing collation information registered in advance with the authentication information; and
authentication processing of performing personal authentication of the user on the basis of a result of the comparison.

### Advantageous Effects of Invention

According to the present disclosure, it is possible to provide an authentication apparatus, an authentication system, an authentication method, and a program capable of appropriately performing personal authentication.

### BRIEF DESCRIPTION OF DRAWINGS

FIG. 1 is a block diagram illustrating a configuration of an authentication apparatus according to a first example embodiment.

FIG. 2 is a flowchart illustrating a state authentication processing according to the first example embodiment.

FIG. 3 is a block diagram illustrating a configuration of an authentication system according to a second example embodiment.

FIG. 4 is a block diagram illustrating a configuration of a biometric authentication apparatus according to the second example embodiment.

FIG. 5 is a flowchart illustrating a flow of biometric information registration processing according to the second example embodiment.

FIG. 6 is a flowchart illustrating a flow of biometric authentication processing according to the second example embodiment.

FIG. 7 is a block diagram illustrating a configuration of state authentication apparatus according to the second example embodiment.

FIG. 8 is a flowchart illustrating a flow of collation information registration processing according to the second example embodiment.

FIG. 9 is a diagram illustrating an example of state master according to the second example embodiment.

FIG. 10 is a diagram illustrating an example of contents stored in a state information DB according to the second example embodiment.

FIG. 11 is a flowchart illustrating a flow of state authentication processing according to the second example embodiment.

FIG. 12 is a view illustrating a display screen for promoting input of state information according to the second example embodiment.

FIG. 13 is a view illustrating an example of a display screen in a case where a user performs motions according to the second example embodiment.

FIG. 14 is a block diagram illustrating a configuration of an authentication terminal according to the second example embodiment.

FIG. 15 is a block diagram illustrating a configuration of a state authentication apparatus in which functions of the authentication terminal according to the second example embodiment are integrated in the same apparatus.

FIG. 16 is a block diagram illustrating a configuration of an authentication apparatus according to a third example embodiment.

FIG. 17 is a flowchart illustrating word authentication processing according to the third example embodiment.

FIG. 18 is a block diagram illustrating a configuration of an authentication system according to a fourth example embodiment.

FIG. 19 is a block diagram illustrating a configuration of a word authentication apparatus according to the fourth example embodiment.

FIG. 20 is a diagram illustrating an example of contents stored in a word information DB according to the fourth example embodiment.

FIG. 21 is a flowchart illustrating a flow of word authentication processing according to the fourth example embodiment.

FIG. 22 is a block diagram illustrating a configuration of an authentication apparatus according to a fifth example embodiment.

FIG. 23 is a flowchart illustrating finger authentication processing according to the fifth example embodiment.

FIG. 24 is a block diagram illustrating a configuration of an authentication system according to a sixth example embodiment.

FIG. 25 is a block diagram illustrating a configuration of a finger authentication apparatus according to the sixth example embodiment.

FIG. 26 is a diagram illustrating an example of contents stored in a finger information DB according to the sixth example embodiment.

FIG. 27 is a flowchart illustrating a flow of finger authentication processing according to the sixth example embodiment.

FIG. 28 is a block diagram illustrating a configuration of an authentication apparatus according to a seventh example embodiment.

FIG. 29 is a flowchart illustrating authentication processing according to the seventh example embodiment.

FIG. 30 is a block diagram illustrating a configuration example of hardware.

### EXAMPLE EMBODIMENT

A method of strictly setting a biometric authentication apparatus is conceivable for the problem caused by the false recognition described in the background art in order to prevent occurrence of false recognition. However, for example, in a case of a face authentication apparatus that performs face authentication, since lighting conditions change depending on a place or time in authentication, it is necessary to set dimming corresponding to the lighting conditions. Therefore, there is a problem that the setting time becomes long in order to improve the accuracy of the face authentication.

In addition, even though the authentication accuracy is improved by sufficiently setting the dimming, it is difficult to set an authentication rate of the face authentication to 100%. Therefore, as another countermeasure, a method of enhancing authentication accuracy by performing multi-modal biometric authentication in which two or more biometric authentication methods are combined is conceivable. For example, in payment processing or the like, it is possible to avoid false recognition by performing two-factor authentication in which face authentication and personal identification number (PIN) authentication are combined. However, in this case, since another instrument is required in addition to an instrument (camera) for face authentication, there is a problem that the cost increases.

Hereinafter, example embodiments of the present disclosure will be described in detail with reference to the drawings. In the drawings, the same or corresponding elements are denoted by the same reference signs, and an overlapping description is omitted as necessary for clarity of description.

### First Example Embodiment

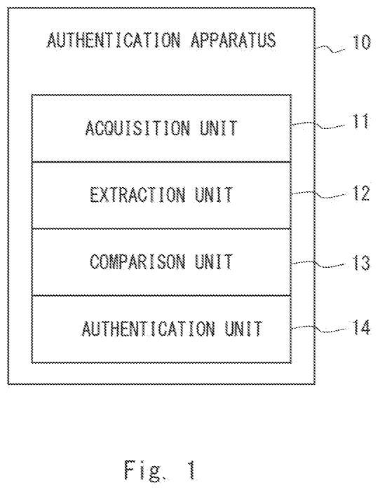

FIG. 1 is a block diagram showing a configuration of the authentication apparatus 10 according to this example embodiment. The authentication apparatus 10 includes an acquisition unit 11, an extraction unit 12, a comparison unit 13, and an authentication unit 14.

The acquisition unit 11 acquires a face image including a face region of a user who has succeeded in face authentication. The extraction unit 12 extracts state information indicating a state of the face region from the face image. The comparison unit 13 compares collation information registered in advance with the state information. The authentication unit 14 performs personal authentication of the user on the basis of a result of the comparison.

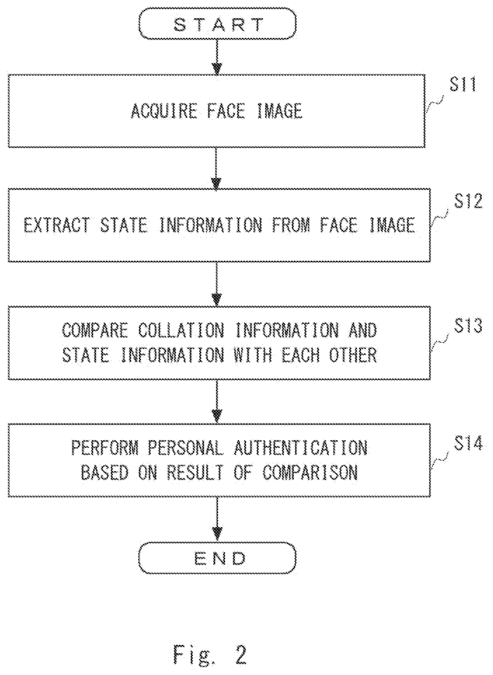

FIG. 2 is a flowchart illustrating a state authentication processing performed by the authentication apparatus 10. The state authentication processing is authentication using the state information acquired from the face image of the user who is a person to be authenticated. The state information is information indicating a state of the face region of the user. The state information is, for example, information indicating that the user has “closed the right eye”.

First, the acquisition unit 11 acquires a face image of the user (S11). The extraction unit 12 extracts state information from the face image (S12). The comparison unit 13 compares the collation information with the state information (S13). The collation information is information for collation which is registered in advance in the authentication apparatus 10 by the user. The authentication unit 14 performs personal authentication of the user on the basis of a result of the comparison (S14). In a case where the collation information and the state information match each other by a predetermined amount or more, the authentication unit 14 determines that the user has succeeded in personal authentication.

As described above, the authentication apparatus 10 according to this example embodiment extracts the state information from the face image of the user who has succeeded in the face authentication, and compares the collation information with the state information to perform personal authentication of the user. In this way, according to the authentication apparatus 10, it is possible to appropriately perform the personal authentication of the user who has succeeded in the face authentication.

### Second Example Embodiment

Next, a second example embodiment according to the present disclosure will be described. This example embodiment is a specific example of the first example embodiment described above.

### (Outline of Authentication System 1000)

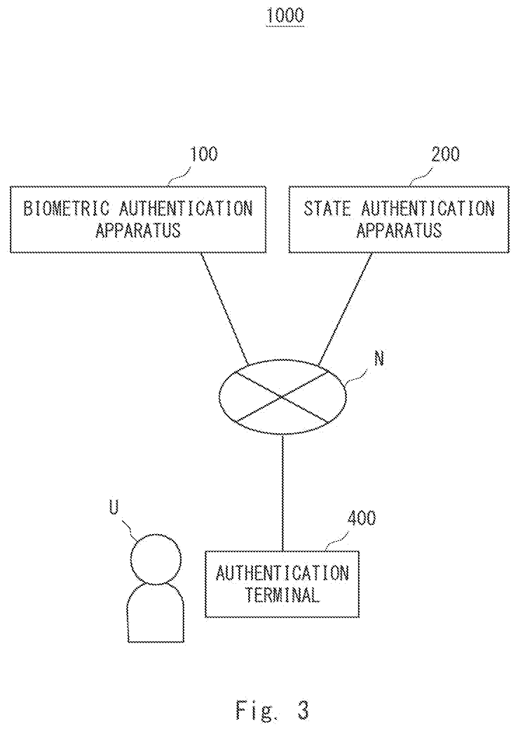

FIG. 3 is a block diagram illustrating a configuration of an authentication system 1000 according to this example embodiment.

The authentication system 1000 includes a biometric authentication apparatus 100, a state authentication apparatus 200, and an authentication terminal 400. The biometric authentication apparatus 100, the state authentication apparatus 200, and the authentication terminal 400 are connected through a network N. It does not matter whether the network N is wired or wireless, and any type of communication protocol may be used.

The authentication system 1000 images a face region of a user U who is a person to be authenticated in the authentication terminal 400, and performs personal authentication of the user U by using the biometric authentication apparatus 100 and the state authentication apparatus 200 on the basis of information acquired from the captured image. The authentication terminal 400 may be installed at a place where the user U is required to be authenticated. The authentication terminal 400 is installed in, for example, a hotel, an apartment, a retail store, a restaurant, or a public facility.

For example, when the user U succeeds in personal authentication with the authentication terminal 400 installed at the entrance of the hotel, the entrance is unlocked, and the user U can enter the hotel. In addition, the authentication terminal 400 may be used for personal authentication when checkout is performed at a retail store, a restaurant, or the like. The installation place and use of the authentication terminal 400 are not limited thereto.

First, the authentication terminal 400 makes a request for the biometric authentication apparatus 100 to perform face authentication, and receives a result of the face authentication from the biometric authentication apparatus 100. In a case where the face authentication has succeeded, the authentication terminal 400 subsequently makes a request for the state authentication apparatus 200 to perform state authentication, and receives a result of the state authentication from the state authentication apparatus 200. In a case where the user U has also succeeded in the state authentication, the authentication terminal 400 determines that the user U has succeeded in the personal authentication. The user U can receive a predetermined service such as entrance to a hotel when succeeding in both the face authentication and the state authentication.

### (Biometric Authentication Apparatus 100)

Next, a configuration of the biometric authentication apparatus 100 will be described.

In response to the biometric authentication request received from the outside, the biometric authentication apparatus 100 is an information processing apparatus that collates the biometric information included in the request with biometric information of each user stored in advance, and returns a collation result (authentication result) to a request source. The biometric information is feature information of biometric information used for biometric authentication. The biometric information is, for example, a face, a voiceprint, a fingerprint, an iris, a vein, or the like. As the biometric information, data (feature amount) calculated from a physical feature unique to an individual such as a face or a voiceprint may be used as the feature information.

In this example embodiment, the biometric authentication apparatus 100 performs the face authentication of the user U by using the facial feature information of the user U as the biometric information. The biometric authentication apparatus 100 receives the face authentication request in combination with the face image of the user U from the authentication terminal 400, performs the face authentication of the user U, and returns the result to the authentication terminal 400.

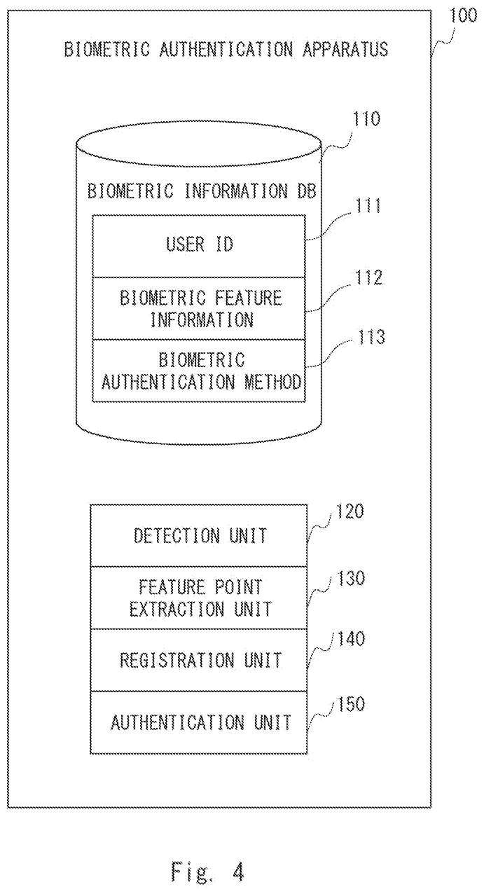

FIG. 4 is a block diagram showing a configuration of the biometric authentication apparatus 100 according to this example embodiment. The biometric authentication apparatus 100 includes a biometric information database (DB) 110, a detection unit 120, a feature point extraction unit 130, a registration unit 140, and an authentication unit 150.

The biometric information DB 110 stores a user ID 111, biometric feature information 112 of the user ID, and a biometric authentication method 113 in association with each other.

The user ID 111 is identification information for identifying the user.

The biometric feature information 112 is a feature amount calculated from a physical feature unique to the individual user. In this example embodiment, the biometric feature information 112 is a set of feature points extracted from a user's face image. In this example embodiment, the biometric feature information 112 may be referred to as facial feature information.

The biometric authentication method 113 is an authentication method such as face authentication, voiceprint authentication, and fingerprint authentication. In this example embodiment, the biometric authentication method 113 is face authentication. In a case where the biometric authentication apparatus 100 performs biometric authentication using a plurality of authentication methods, the biometric authentication method 113 may include a plurality of different authentication methods. The biometric authentication apparatus 100 may perform the biometric authentication by using the biometric feature information 112 corresponding to a requested authentication method.

The detection unit 120 detects a face region included in a registration image for registering facial feature information and outputs the face region to the feature point extraction unit 130.

The feature point extraction unit 130 extracts feature points from the face region detected by the detection unit 120 and outputs facial feature information to the registration unit 140.

In addition, the feature point extraction unit 130 extracts feature points included in the face image received from the authentication terminal 400, and outputs facial feature information to the authentication unit 150.

The registration unit 140 newly issues the user ID 111 when registering the biometric feature information. The registration unit 140 registers the issued user ID 111 and the biometric feature information 112 extracted from the registration image in the biometric information DB 110 in association with each other.

The authentication unit 150 performs biometric authentication by using the biometric feature information 112. Specifically, the authentication unit 150 collates the facial feature information extracted from the face image with the biometric feature information 112 in the biometric information DB 110. In a case where the collation has succeeded, the authentication unit 150 specifies the user ID 111 associated with the collated biometric feature information 112.

The authentication unit 150 returns whether or not the pieces of biometric feature information match each other to the authentication terminal 400 as a result of the biometric authentication. Whether or not the pieces of biometric feature information match with each other corresponds to whether or not authentication has succeeded or failed. Note that, a case where the pieces of biometric feature information match each other represents a case where the degree of matching is equal to or larger than a predetermined value. Further, in a case where the biometric authentication has succeeded, it is assumed that the biometric authentication result includes the specified user ID 111.

### (Face Information Registration Processing)

Next, face information registration processing according to this example embodiment will be described.

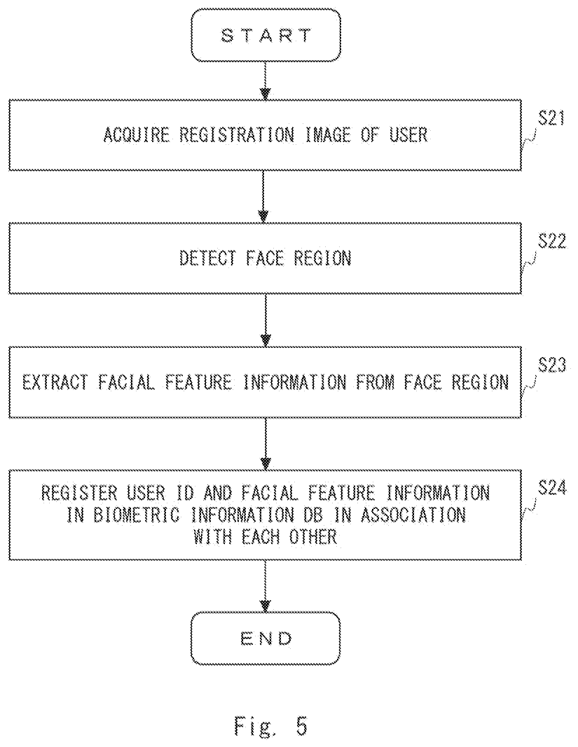

FIG. 5 is a flowchart illustrating a flow of face information registration processing according to this example embodiment. First, the biometric authentication apparatus 100 acquires the registration image included in a face information registration request (S21). For example, the biometric authentication apparatus 100 receives the face information registration request from the authentication terminal 400, a registration website, or the like through the network N.

Next, the detection unit 120 detects a face region included in the registration image (S22). Next, the feature point extraction unit 130 extracts a feature point from the face region detected in step S22 and outputs biometric feature information 112 to the registration unit 140 (S23). Finally, the registration unit 140 issues the user ID 111, and registers the user ID 111 and the biometric feature information 112 in the biometric information DB 110 in association with each other (S24). The biometric authentication apparatus 100 may receive the biometric feature information 112 from a communication terminal or the like possessed by the user U and register the biometric feature information 112 and the user ID 111 in the biometric information DB 110 in association with each other.

### (Face Authentication Processing)

Next, a flow of the face authentication processing will be described.

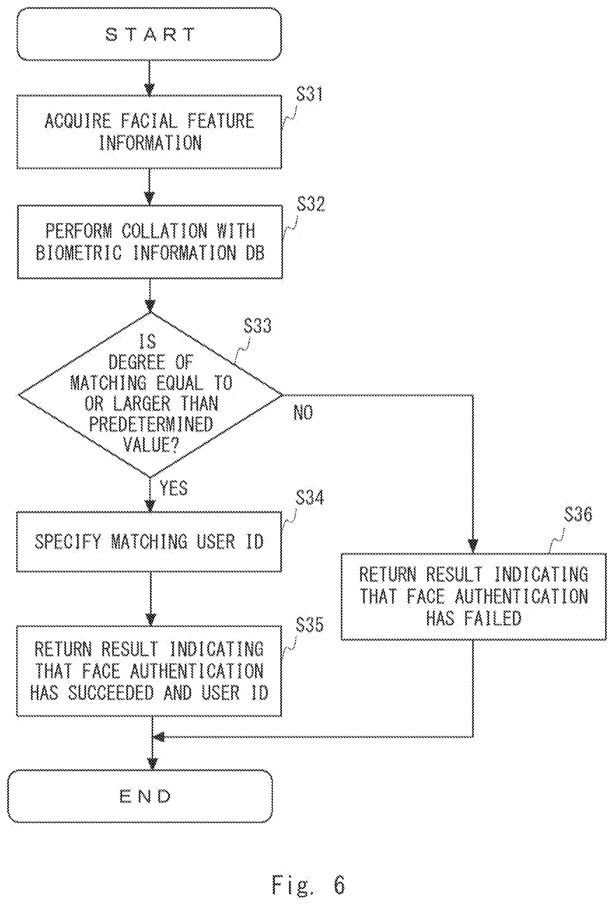

FIG. 6 is a flowchart showing a flow of face authentication processing by the biometric authentication apparatus 100 according to this example embodiment.

First, the detection unit 120 detects a face region of the user from the face image included in the face authentication request, and the feature point extraction unit 130 acquires facial feature information from the detected face region (S31). For example, the biometric authentication apparatus 100 receives the face authentication request from the authentication terminal 400 through the network N, and extracts facial feature information from the face image included in the face authentication request, or the like as in steps S21 to S23. Note that, the face image included in the face authentication request may be a still image or a moving image. In a case where the face authentication request includes a moving image, the detection unit 120 detects a face region included in each frame image of the moving image. The feature point extraction unit 130 extracts a feature point from the face region detected in the frame image.

Next, the authentication unit 150 collates the acquired facial feature information with the biometric feature information 112 in the biometric information DB 110 (S32). In a case where the pieces of facial feature information match each other, that is, the degree of matching between the pieces of facial feature information is equal to or larger than a predetermined value (YES in S33), the authentication unit 150 specifies the user ID 111 of the user U whose facial feature information matches (S34). Then, the authentication unit 150 returns, as a response, a result indicating that the face authentication has succeeded and the specified user ID 111 to the authentication terminal 400 (S35). In a case where there is no matching facial feature information (NO in S33), the authentication unit 150 returns, as a response, a result indicating that the biometric authentication has failed to the authentication terminal 400 (S36).

Note that, in step S32, the authentication unit 150 does not need to attempt collation with all pieces of biometric feature information 112 in the biometric information DB 110. The authentication unit 150 may preferentially attempt collation with the biometric feature information 112 registered in a period from the day of reception of the biometric authentication request to several days before. As a result, a collation speed can be improved. In a case where the preferential collation has failed, it is desirable that collation with all pieces of remaining biometric feature information 112 is performed.

### (State Authentication Apparatus 200)

Next, the configuration of the state authentication apparatus 200 will be described with reference to FIG. 3 again. The state authentication apparatus 200 is an example of the authentication apparatus 10 in the first example embodiment.

The state authentication apparatus 200 is an information processing apparatus that collates state information included in the request with collation information of each user U in response to a state authentication request received from the outside, and returns a collation result (authentication result) to a request source. In this example embodiment, the state authentication apparatus 200 receives a state authentication request with respect to the user U who has succeeded in the face authentication from the authentication terminal 400. The state authentication apparatus 200 performs state authentication with respect to the user U and returns a result of the state authentication to the authentication terminal 400.

The state information is information indicating a state of the face region of the user U. The state of the face region of the user U indicates that the face region is in which state as compared with the normal time. The state information may indicate a change generated in an expression of the user U, for example, “closing the right eye”, “opening mouth”, or the like. Further, the state information may indicate that the user U wears an article on the face region such as “wearing a mask” or “wearing glasses”. In addition, in a case where the camera that images the face region can capture a moving image, the state information may indicate movement of the face region such as “blinking” and “turning the neck”.

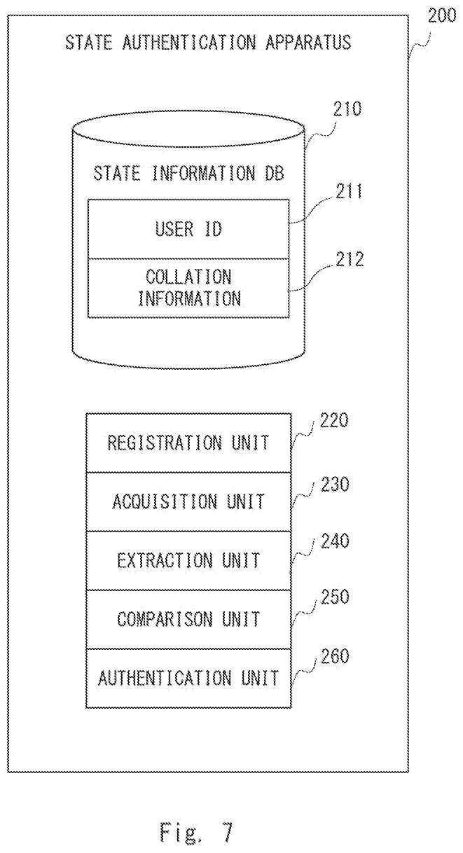

Next, a configuration of the state authentication apparatus 200 will be described with reference to FIG. 7. FIG. 7 is a block diagram showing a configuration of the state authentication apparatus 200 according to this example embodiment. The state authentication apparatus 200 includes a state information DB 210, a registration unit 220, an acquisition unit 230, an extraction unit 240, a comparison unit 250, and an authentication unit 260.

The state information DB 210 stores a user ID 211 and collation information 212 in association with each other.

The user ID 211 is identification information for identifying the user. The user ID 211 corresponds to the user ID 111 of the biometric information DB 110.

The collation information 212 is information for collation, used for comparison with the state information. The collation information 212 includes state contents indicating the state of the face region of the user U. The collation information 212 may include a plurality of state contents.

The registration unit 220 newly issues the user ID 211 when registering the collation information 212. The registration unit 220 registers the issued user ID 211 and the collation information 212 in the state information DB 210 in association with each other.

The acquisition unit 230 corresponds to the acquisition unit 11 in the first example embodiment. The acquisition unit 230 acquires the face image including the face region of the user U who has succeeded in the face authentication in the biometric authentication apparatus 100 from the authentication terminal 400. The face image is included in the state authentication request transmitted from the authentication terminal 400. The face image may be a still image or a moving image.

The extraction unit 240 corresponds to the extraction unit 12 in the first example embodiment. The extraction unit 240 extracts state information indicating a state of the face region from the face image. The extraction unit 240 calculates a difference between an image at the normal time and an image whose state has been changed, and extracts state information. The present disclosure is not limited thereto, and the extraction unit 240 may extract the state information by using any method. Note that, in a case where a moving image is included in the state authentication request, the extraction unit 240 extracts state information for each frame image of the moving image.

The comparison unit 250 corresponds to the comparison unit 13 in the first example embodiment. The comparison unit 250 compares the collation information 212 registered in advance with the state information extracted by extraction unit 240. The comparison unit 250 compares the collation information 212 with the state information a plurality of times, and counts the number of times of matching. The comparison unit 250 may perform the comparison according to order information included in the collation information 212. The order information will be described later. Note that, in a case where the moving image is included in the state authentication request, the comparison unit 250 compares the state information of each frame image extracted by the extraction unit 240 with the collation information 212 registered in advance.

The authentication unit 260 corresponds to the authentication unit 14 in the first example embodiment. The authentication unit 260 performs personal authentication of the user U on the basis of a plurality of comparison results in the comparison unit 250. The authentication unit 260 determines that the personal authentication has succeeded in a case where the number of times of matching between the collation information 212 and the state information is equal to or larger than a threshold value.

The threshold value used for the determination of the state authentication may be set by the user U or may be set in correspondence with the number of the registered collation information 212. For example, a predetermined ratio (for example, 30%) of a plurality of pieces of the collation information 212 may be used as the threshold value.

The threshold value may be set in correspondence with a determination condition of the face authentication performed before the state authentication. For example, the threshold value is set to decrease as the determination condition of the face authentication becomes stricter. The strict determination condition of the face authentication represents that the matching degree of the facial feature information to be compared is high in the determination of the face authentication in the authentication unit 150. As a higher matching degree is required as a determination condition of successful authentication, the face authentication is less likely to succeed. That is, as the determination condition of the face authentication becomes stricter, there is a higher possibility that the face authentication fails because the matching degree is not satisfied even for a valid user himself/herself. On the other hand, a loose determination condition represents that the matching degree necessary for the successful face authentication is low.

For example, the threshold value is set to 30% in a case where the determination condition of the face authentication is strict, and the threshold value is set to 50% in a case where the determination condition of the face authentication is loose. In this way, the severity of the determination condition in the state authentication can be made different in correspondence with the severity of the determination condition of the face authentication. Therefore, for example, even when the determination condition of the face authentication becomes loose by shortening the time required for dimming the face authentication, the accuracy of the personal authentication can be improved by making the determination condition of the state authentication stricter.

### (Collation Information Registration Processing)

Next, registration processing of the collation information 212 according to this example embodiment will be described.

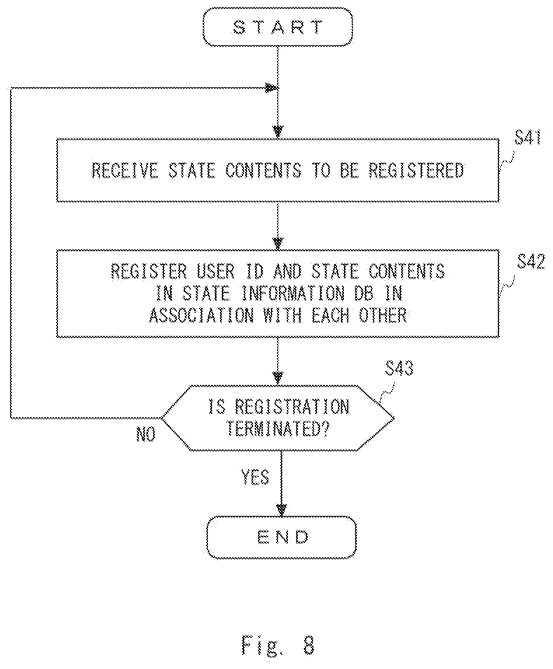

FIG. 8 is a flowchart illustrating a flow of collation information registration processing according to the example embodiment. The collation information 212 is information used for collation in a case of the state information. The user U registers state contents used for authentication in advance from the authentication terminal 400, a registration website, or the like.

First, the state authentication apparatus 200 receives the state contents included in a collation information registration request from the user U (S41). For example, the state authentication apparatus 200 receives the collation information registration request from the authentication terminal 400, the registration website, or the like through the network N. The state authentication apparatus 200 may store candidates for the state contents to be registered in advance in a storage unit (not illustrated) of the state authentication apparatus 200 as a state master, and cause the user U to select a desired state from the candidates.

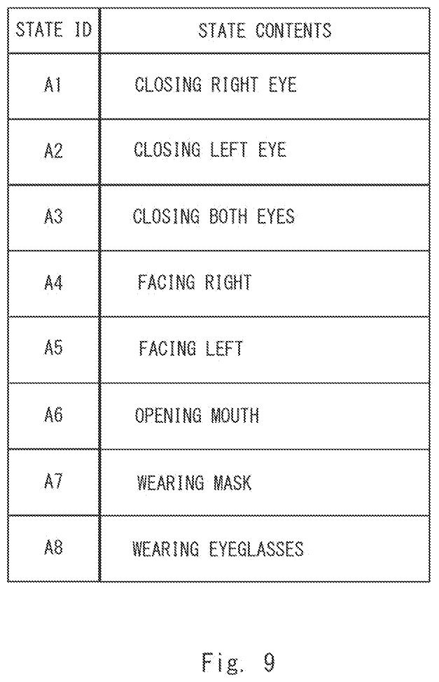

FIG. 9 is a view showing an example of the state master. The state master stores, for example, a state ID for identifying state contents and the state contents in association with each other. The state authentication apparatus 200 causes the authentication terminal 400 or the like to display the content of the state master and causes the user U to select the state content. The state authentication apparatus 200 receives the state content selected by the user U in combination with the collation information registration request.

Returning to FIG. 8, the description will be continued. The registration unit 220 issues the user ID 211, and registers the user ID 211 and the state content in the state information DB 210 in association with each other (S42). The registration unit 220 determines whether registration of the state contents is completed (S43). For example, the registration unit 220 determines termination of the registration of the state contents in response to reception of a notification for termination of the registration from the user U. The user U can register a desired number of state contents. The registration unit 220 may cause the user U to register a predetermined number or more of state contents.

In a case where the registration of the state contents is terminated (YES in S43), the process is terminated, and when the registration of the state contents is not terminated (NO in S43), the process returns to step S41. The registration unit 220 registers a plurality of state contents per user U by repeating the processing in steps S41 and S42. The registration unit 220 stores the user ID 211 and the collation information 212 in association with each other.

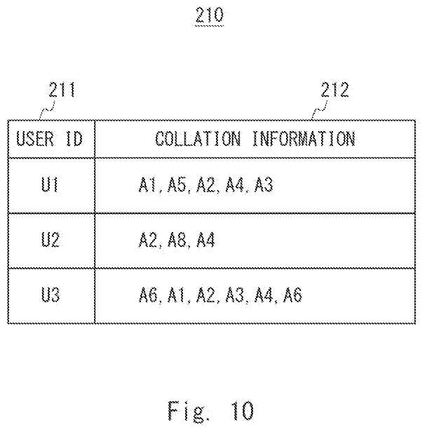

FIG. 10 is a view showing an example of contents stored in a state information DB 210. The collation information 212 includes a plurality of state IDs selected from the information master. As shown in the drawing, the number of the registered collation information 212 may be different depending on the user. Note that, in a case where the collation order is taken into consideration, a plurality of the same state contents may be registered. For example, a plurality of state IDs “A1” indicating “closing the right eye” may be registered.

Here, the above-described order information will be described with reference to FIG. 10. The order information is information indicating an authentication order or a comparison order of the state information. For example, in a case of a user U2, the order information is registered as “A2” for the first, “A8” for the second, and “A4” for the third. Then, only in a case where the state information indicated by a first face image is “closing the left eye”, the comparison unit 250 counts as matching. In other words, in a case where the first face image indicates a state of wearing glasses or a state of facing the right, the comparison unit 250 counts as non-matching. Similarly, the comparison unit 250 determines whether or not matching is established in second and third face images.

Furthermore, the registration unit 220 may receive an input from the user U and set a threshold value used for determination of state authentication. The state authentication can be performed more strictly by setting the threshold value to be high. For example, the user U1 registers five state contents as the collation information 212. The registration unit 220 receives an input of a threshold value of 5 or less from the user U1 and sets the threshold value. For example, in a case where the threshold value is 3, the user U1 can succeed in the state authentication by correctly answering to three among five registered state contents.

The threshold value may be set in advance by the registration unit 220. For example, the registration unit 220 may set a predetermined ratio (for example, 30%) of the number of registered state contents as the threshold value. Note that, the method of setting the threshold value is not limited thereto.

Furthermore, the registration unit 220 may cause the user U to select whether or not to consider the authentication order of the registered state contents. For example, the user U1 may select whether or not to consider the authentication as being successful only in a case where matching of the authentication order of the three state contents satisfying the threshold value is established. The state authentication can be performed more strictly by limiting the authentication order.

Note that, here, although description has been made with reference to the case where the user U selects a desired state content from the state master, the present disclosure is not limited thereto. Similarly to registration of the face information, a face region of the user U may be imaged by using a camera and a motion such as “closing the right eye” may be detected, and the detection result may be registered in the state content. In addition, similarly to the facial feature information, a feature amount for each motion may be calculated, and the calculation result may be registered in the state content.

### (State Authentication Processing)

Next, state authentication processing according to this example embodiment will be described.

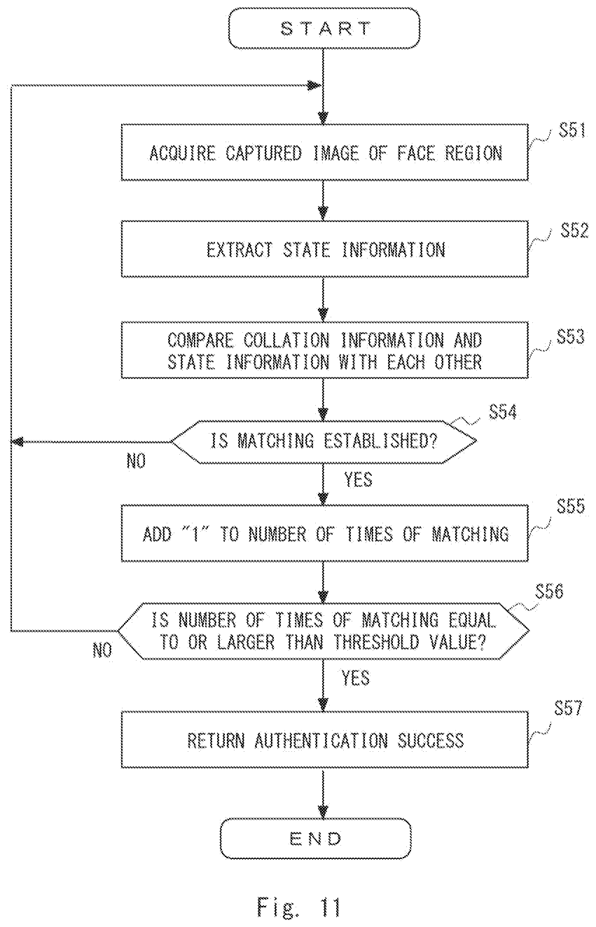

FIG. 11 is a flowchart illustrating a flow of state authentication processing according to this example embodiment. The state authentication apparatus 200 receives a state authentication request from the authentication terminal 400 and initiates state authentication processing. The state authentication request includes the user ID 111 specified by the biometric authentication apparatus 100.

First, the acquisition unit 230 acquires a face image of the user U from the authentication terminal 400 (S51). The extraction unit 240 extracts state information indicating a state of a face region from the face image (S52). The comparison unit 250 compares the collation information 212 registered in advance with the extracted state information (S53).

The comparison unit 250 determines whether or not the collation information 212 and the state information match each other (S54). For example, it is assumed that state information “closing the right eye” is extracted in the extraction unit 240. The comparison unit 250 refers to the collation information 212 and confirms whether or not the state content of “closing the right eye” is registered in the collation information 212 of the user U. In a case where “closing the right eye” is registered, the comparison unit 250 determines that the collation information 212 and the state information match each other. In a case where the authentication order is taken into consideration, the comparison unit 250 performs determination including whether or not the order of the extracted state information matches the order information.

In a case where the collation information 212 and the state information do not match each other (NO in S54), the process returns to step S51. In a case where collation information 212 and the state information match each other (YES in S54), the comparison unit 250 adds “1” to the number of times of matching (S55).

Note that, an initial value of the number of times of matching is 0 at the start of the present processing.

The authentication unit 260 determines whether or not the number of times of matching is equal to or larger than a threshold value (S56). In a case where the number of times of matching is less than the threshold value (NO in S56), the process returns to step S51. In a case where the number of times of matching is equal to or larger than the threshold value (YES in S56), the authentication unit 260 returns the fact that the state authentication has succeeded to the authentication terminal 400 (S57).

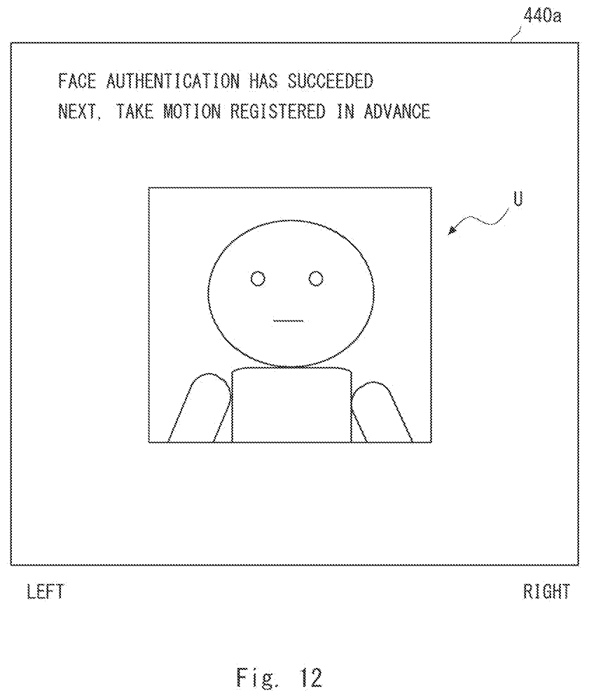

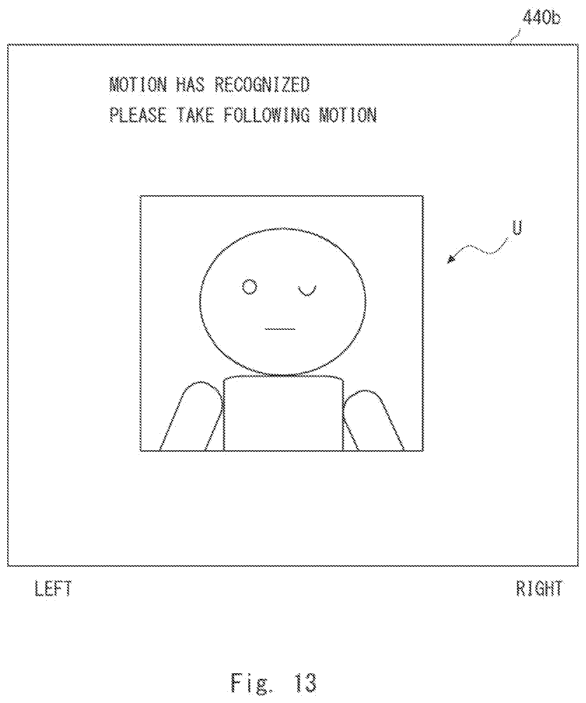

The above-described state authentication processing can be proceeded by appropriately instructing the user U in the authentication terminal 400. FIG. 12 and FIG. 13 are views illustrating an example of a display screen displayed on the display unit 440. The user U performs the state authentication following the face authentication while looking at the display unit 440.

FIG. 12 is a view illustrating a display screen 440a for prompting the user U to input state information. The face image of the user U is displayed on the display screen 440a in real time. The right side in FIG. 12 is the right side of the face region of the user U, and the left side is the left side of the face region of the user U. As illustrated in the drawing, the display unit 440 displays, for example, a message such as “face authentication has succeeded. Next, please take a motion registered in advance” is displayed to prompt the user U to perform the state authentication.

FIG. 13 is a diagram illustrating a display screen 440b in a case where the user U takes a motion. Here, the user U is taking a motion of “closing the right eye”. The acquisition unit 230 of the state authentication apparatus 200 images a face region of the user U at this time and outputs the face region to the extraction unit 240. The extraction unit 240 calculates a difference from a face region of the user U at the normal time, and extracts state information of the user U. The face region at the normal time may be imaged when the display screen 440a is displayed, or a captured image at the time of face authentication may be used.

When the extraction unit 240 extracts the state information, the display unit 440 displays a voice message like “motion has been recognized. Please, take the following motions”. In a case where the user U has correctly given answers equal to or larger than the threshold value, for example, a message such as “personal authentication has succeeded.” is displayed, and the processing is terminated. In addition, in a case where the user U cannot correctly give answers equal to or larger than the threshold value, a message such as “state authentication failed.” is displayed, and the processing is terminated or authentication is performed again up to a predetermined limit number of times.

Note that, in the above-described method, the state information is input by prompting the user U to input the state information one by one by using the display screens 440a and 440b, but the present disclosure is not limited thereto. The state information may be continuously input by the user U.

For example, the user U takes a motion such as “wearing a mask” or “wearing glasses” in front of the camera of the authentication terminal 400. The authentication terminal 400 captures a moving image of the motion of the user U during that time (for example, 5 seconds). The authentication terminal 400 transmits a state authentication request including the acquired moving image to the state authentication apparatus 200. The acquisition unit 230 receives the state authentication request including the moving image from the authentication terminal 400. The extraction unit 240 extracts state information for each frame image of the moving image. The comparison unit 250 compares the state information of each frame image and the collation information 212 registered in advance with each other. In a case where the state information in the frame image is included in collation information 212, comparison unit 250 adds “1” to the number of times of matching.

In this way, the user U can input the state information by continuously taking a plurality of motions. Therefore, the state authentication can be performed in a shorter time. Note that, similar processing may be performed by using not only the moving image but also a plurality of still images. For example, the authentication terminal 400 may capture a plurality of still images of the user U within a predetermined time (for example, 5 seconds), include the images in the state authentication request, and transmit the state authentication request to the state authentication apparatus 200.

### (Authentication Terminal 400)

Next, the authentication terminal 400 will be described.

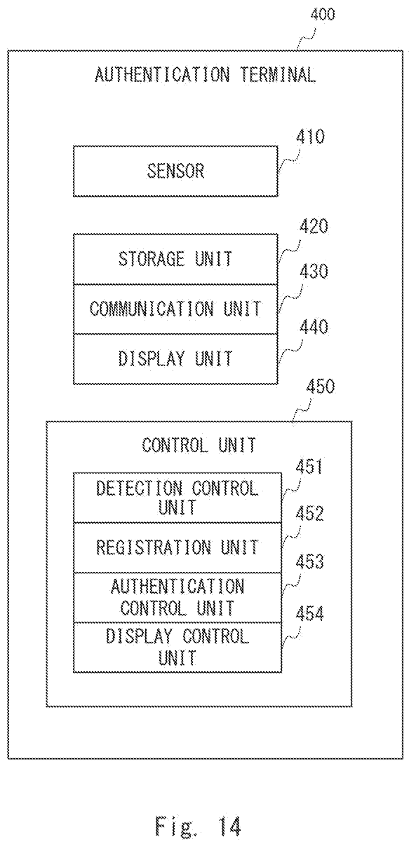

FIG. 14 is a block diagram showing a configuration of the authentication terminal 400 according to this example embodiment. The authentication terminal 400 includes a sensor 410, a storage unit 420, a communication unit 430, a display unit 440, and a control unit 450.

The sensor 410 acquires information used for personal authentication of the user U under the control of a control unit 450. In this example embodiment, the sensor 410 is a camera that images the user U and acquires a face image including a face region of the user U. The sensor 410 acquires the face image used in face authentication and state authentication of the user U. Therefore, the authentication terminal 400 does not need to include a plurality of the sensors 410. The present disclosure is not limited thereto, and the authentication terminal 400 may include the plurality of sensors 410.

The storage unit 420 is a storage apparatus that stores a program for realizing each function of the authentication terminal 400.

The communication unit 430 is a communication interface with the network N.

The display unit 440 is at least a display apparatus. Furthermore, the display unit 440 may be an input/output unit including a display apparatus and an input apparatus, for example, a touch panel. The display unit 440 displays, for example, a screen such as the display screen 440a or 440b described above.

The control unit 450 controls hardware included in the authentication terminal 400. The control unit 450 includes a detection control unit 451, a registration unit 452, an authentication control unit 453, and a display control unit 454.

The detection control unit 451 controls the sensor 410 to capture a registration image or an authentication image of the user U. The registration image and the authentication image captured by the sensor 410 are images including at least the face region of the user U. The detection control unit 451 outputs the registration image or the state contents to the registration unit 452. In addition, the detection control unit 451 outputs a biometric authentication image or a state authentication image to the authentication control unit 453.

The registration unit 452 transmits a biometric information registration request including the registration image to the biometric authentication apparatus 100 through the network N. In addition, the registration unit 452 transmits a state information registration request including the state contents to the state authentication apparatus 200 through the network N.

The authentication control unit 453 transmits a biometric authentication request including a biometric authentication image to the biometric authentication apparatus 100 through the network N. In a case where the user U has succeeded in the biometric authentication, the authentication control unit 453 transmits a state authentication request including a state authentication image to the state authentication apparatus 200 through the network N.

The authentication control unit 453 receives a biometric authentication result or a state authentication result, and outputs the biometric authentication result or the state authentication result to the display control unit 454. In a case where these authentication results are successful, the authentication control unit 453 outputs an instruction signal for causing a control instrument of a predetermined service to execute the service. Examples of the predetermined service include opening and closing of a door (gate), unlocking of a lock, execution of payment processing, execution of check-in processing, execution of check-out processing, and the like. As a result, the user U can receive the predetermined service.

The display control unit 454 displays display contents corresponding to the biometric authentication result or the state authentication result on the display unit 440. For example, the display control unit 454 displays that the authentication has succeeded or failed to the user U. Furthermore, the display control unit 454 may display the name and the like of the user U on the display unit 440 in combination with the authentication result. For example, the display control unit 454 displays “Mr./Ms. ∘∘, the face authentication has succeeded.”, “Mr./Ms. ∘∘, the face authentication and the state authentication have succeeded.”, or the like.

As described above, according to the authentication system 1000 according to this example embodiment, the face authentication of the user U is performed in the biometric authentication apparatus 100, and the state authentication is performed in the state authentication apparatus 200 in correspondence with the success of the face authentication. The state authentication apparatus 200 acquires a face image of the user U and extracts state information in a face region. The state authentication apparatus 200 compares the collation information registered in advance with the state information, and determines whether or not the state authentication has succeeded on the basis of a result of the comparison. The state authentication apparatus 200 determines that the personal authentication has succeeded in a case where the number of times of matching between the collation information and the state information is equal to or larger than a threshold value. The threshold value can be set in correspondence with the number of the registered collation information. For example, the threshold value is set to satisfy a predetermined ratio of the number of the registered collation information. In addition, the threshold value can be set in correspondence with a determination condition of the face authentication. For example, the threshold value can be set to decrease as the determination condition of the face authentication becomes stricter.

In the authentication system 1000 according to this example embodiment, for example, a motion that only the person himself/herself can know such as “closing right eye” and “wearing glasses” is registered as the collation information. In addition, a plurality of pieces of collation information is registered, and a condition in which answers equal to or larger than the threshold value are correctly given is set as a determination condition for authentication success. Therefore, it is possible to reduce the possibility that a person other than the user himself/herself succeeds in authentication. In addition, since the accuracy of the personal authentication can be improved by performing the state authentication, the determination condition of the face authentication can be loosened. Therefore, in the face authentication, the setting time required for dimming can be shortened.

In addition, unlike an authentication system that performs multi-modal authentication, the authentication system 1000 according to this example embodiment does not need to include a plurality of types of sensors. Therefore, it is possible to appropriately perform personal authentication without complicating the system or increasing the cost.

Note that, the configuration of the authentication system 1000 illustrated with reference to FIG. 3 is merely an example. Each of the biometric authentication apparatus 100, the state authentication apparatus 200, and the authentication terminal 400 may be configured by using an apparatus in which a plurality of configurations is integrated, or respective functional units may be subjected to distributed processing by using a plurality of apparatuses.

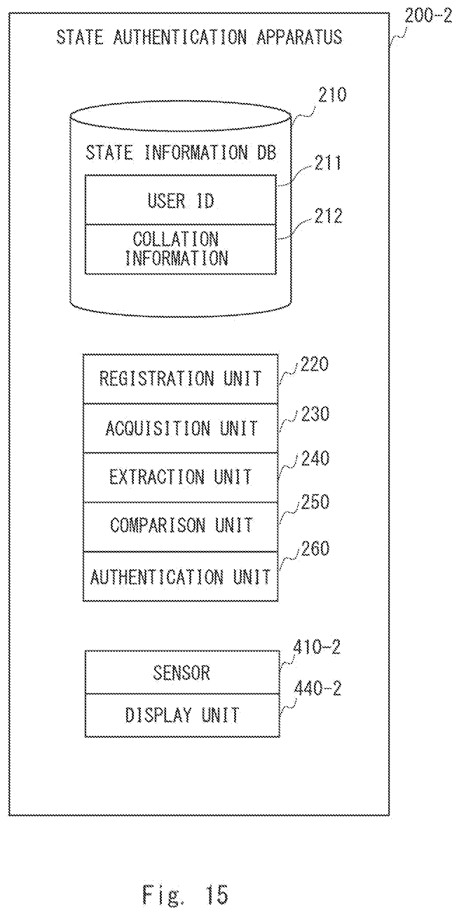

For example, the functions of the state authentication apparatus 200 and the authentication terminal 400 may be integrated in the same apparatus. FIG. 15 is a block diagram illustrating a configuration of a state authentication apparatus 200-2 in which functions of the authentication terminal 400 are integrated in the same apparatus. The state authentication apparatus 200-2 includes a sensor 410-2 and a display unit 440-2 in addition to the configuration of the state authentication apparatus 200 described with reference to FIG. 7. The sensor 410-2 and the display unit 440-2 correspond to the sensor 410 and the display unit 440 in the authentication terminal 400, respectively. Note that, the functional units of the detection control unit 451, the registration unit 452, the authentication control unit 453, and the display control unit 454 may be configured to have appropriately corresponding functions by the registration unit 220, the acquisition unit 230, the extraction unit 240, the comparison unit 250, the authentication unit 260, and the like.

With such a configuration, the state authentication apparatus 200-2 can acquire the state information from the user U and perform the state authentication without using the network N. Similarly to the authentication terminal 400, the state authentication apparatus 200-2 may be installed at an entrance of a hotel or the like. Note that, the state authentication apparatus 200-2 may be configured to further include the function of the biometric authentication apparatus 100.

### Third Example Embodiment

Next, a third example embodiment according to the present disclosure will be described.

In the first and second example embodiments, the personal authentication of the user U is performed by using the information relating to the face region of the user U. In the third example embodiment, personal authentication of the user U is performed by using information relating to the voice of the user U.

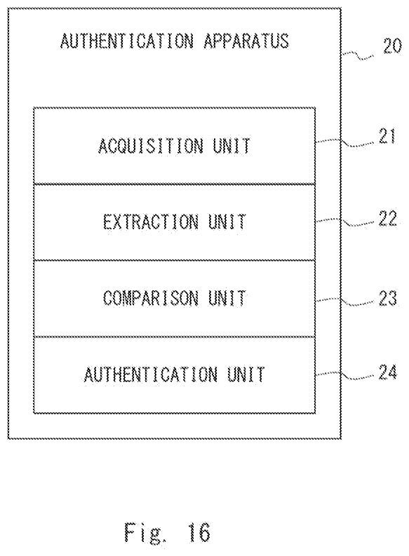

FIG. 16 is a block diagram showing a configuration of an authentication apparatus 20 according to this example embodiment.

The authentication apparatus 20 includes an acquisition unit 21, an extraction unit 22, a comparison unit 23, and an authentication unit 24.

The acquisition unit 21 acquires the voice of the user who has succeeded in voiceprint authentication. The extraction unit 22 extracts word information included in the voice. The comparison unit 23 compares collation information registered in advance with the word information. The authentication unit 24 performs personal authentication of the user on the basis of a result of the comparison.

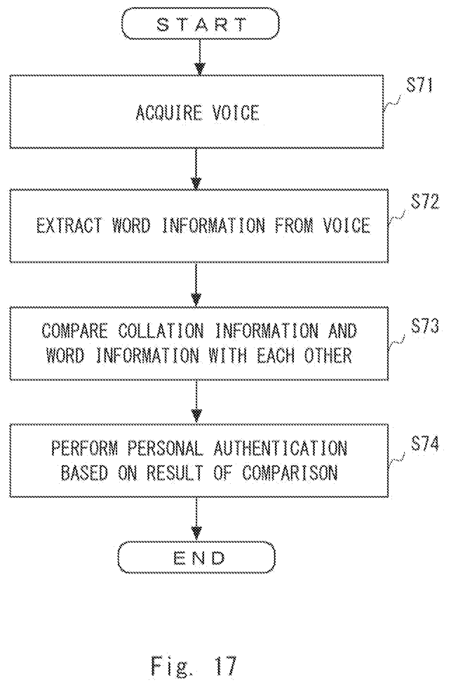

FIG. 17 is a flowchart illustrating a word authentication processing performed by the authentication apparatus 20. The word authentication processing is authentication processing using word information acquired from a voice uttered by a user who is a person to be authenticated. The word information is not limited to a word, and may include a sentence.

First, the acquisition unit 21 acquires the voice of the user who has succeeded in the voiceprint authentication (S71). The extraction unit 22 extracts word information from the voice (S72). The word information is information indicating a word or a sentence included in the voice of the user. The comparison unit 23 compares the collation information with the word information (S73). The collation information is information for collation which is registered in advance in the authentication apparatus 20 by the user. The authentication unit 24 performs personal authentication of the user on the basis of a result of the comparison (S74). In a case where the collation information and the word information match each other by a predetermined amount or more, the authentication unit 24 determines that the user has succeeded in personal authentication.

As described above, according to the authentication apparatus 20 of this example embodiment, the word information is extracted from the voice of the user, and the collation information is compared with the word information to perform the personal authentication of the user. In this way, it is possible to appropriately perform the personal authentication of the user who has succeeded in the voiceprint authentication.

### Fourth Example Embodiment

Next, a fourth example embodiment according to the present disclosure will be described. This example embodiment is a specific example of the third example embodiment.

### (Outline of Authentication System 1001)

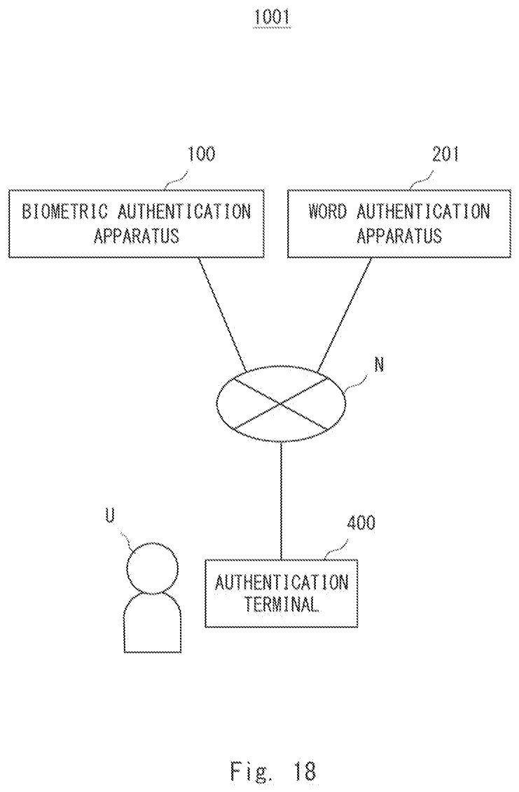

FIG. 18 is a block diagram illustrating a configuration of an authentication system 1001 according to this example embodiment. Note that, detailed description of contents overlapping with the second example embodiment already described may be omitted. Hereinafter, differences from the second example embodiment will be mainly described.

The authentication system 1001 includes a biometric authentication apparatus 100, a word authentication apparatus 201, and an authentication terminal 400. The biometric authentication apparatus 100, the word authentication apparatus 201, and the authentication terminal 400 are connected through the network N.

The authentication system 1001 acquires a voice of the user U who is a person to be authenticated in the authentication terminal 400, and performs personal authentication of the user U by using the biometric authentication apparatus 100 and the word authentication apparatus 201 on the basis of information extracted from the voice. Since an installation place and the like of the authentication terminal 400 are similar to those of the authentication system 1000 described in the second example embodiment, detailed description thereof will be omitted.

First, the authentication terminal 400 makes a request for the biometric authentication apparatus 100 to perform voiceprint authentication, and receives a result of the voiceprint authentication from the biometric authentication apparatus 100. In a case where the voiceprint authentication has succeeded, the authentication terminal 400 subsequently makes a request for the word authentication apparatus 201 to perform word authentication, and receives a result of the word authentication from the state authentication apparatus 200. In a case where the user U has also succeeded in the word authentication, the authentication terminal 400 determines that the user U has succeeded in the personal authentication.

### (Biometric Authentication Apparatus 100)

Next, a configuration of the biometric authentication apparatus 100 will be described.

In the second example embodiment, the biometric authentication apparatus 100 performs the face authentication as the biometric authentication. In this example embodiment, the biometric authentication apparatus 100 performs voiceprint authentication instead of the face authentication. The biometric authentication apparatus 100 performs the voiceprint authentication of the user U by using voiceprint feature information of the user U as the biometric information. The biometric authentication apparatus 100 receives the voiceprint authentication request in combination with the voice of the user U from the authentication terminal 400, performs the voiceprint authentication of the user U, and returns the result to the authentication terminal 400.

The configuration of the biometric authentication apparatus 100 is similar to that described in the second example embodiment with reference to FIG. 4. As illustrated in FIG. 4, the biometric authentication apparatus 100 includes the biometric information DB 110, the detection unit 120, the feature point extraction unit 130, the registration unit 140, and the authentication unit 150. The configuration of each functional unit can be described by replacing the facial feature information in the second example embodiment with the voiceprint feature information, and thus the detailed description thereof is omitted here.

### (Voiceprint Information Registration Processing)

In this example embodiment, the voiceprint feature information of the user U is registered as the biometric information. The flow of the registration processing is similar to the facial feature information registration processing described with reference to the flowchart shown in FIG. 5. Hereinafter, the flow of the registration processing will be described in a simplified manner by appropriately replacing the contents with reference to FIG. 5.

The biometric authentication apparatus 100 acquires the voice of the user from the authentication terminal 400 or the like (S21). Next, the detection unit 120 detects a voiceprint from the acquired voice (S22). Then, the feature point extraction unit 130 extracts voiceprint feature information from the voiceprint (S23). Finally, the registration unit 140 registers the user ID 111 and the biometric feature information (voiceprint feature information) 112 in the biometric information DB 110 in association with each other (S24).

### (Voiceprint Authentication Processing)

In this example embodiment, voiceprint authentication is performed as biometric authentication processing. The flow of the biometric authentication processing is similar to the face authentication processing described with reference to the flowchart shown in FIG. 6. Since the biometric authentication processing can be described by replacing the facial feature information in the second example embodiment with the voiceprint feature information, detailed description thereof will be omitted here.

### (Word Authentication Apparatus 201)

Next, referring back to FIG. 18, the word authentication apparatus 201 will be described. The word authentication apparatus 201 is an example of the authentication apparatus 20 in the third example embodiment.

The word authentication apparatus 201 is an information processing apparatus that collates word information included in the request with collation information of each user U in response to the word authentication request received from the outside, and returns a collation result (authentication result) to a request source. In this example embodiment, the word authentication apparatus 201 receives the word authentication request with respect to the user U who has succeeded in the voiceprint authentication from the authentication terminal 400. The word authentication apparatus 201 performs word authentication with respect to the user U and returns a result of the word authentication to the authentication terminal 400.

The word information is information indicating a word or a sentence included in the voice uttered by the user U. The word information is, for example, “apple”, “orange”, “good morning”, “It's sunny today”, or the like.

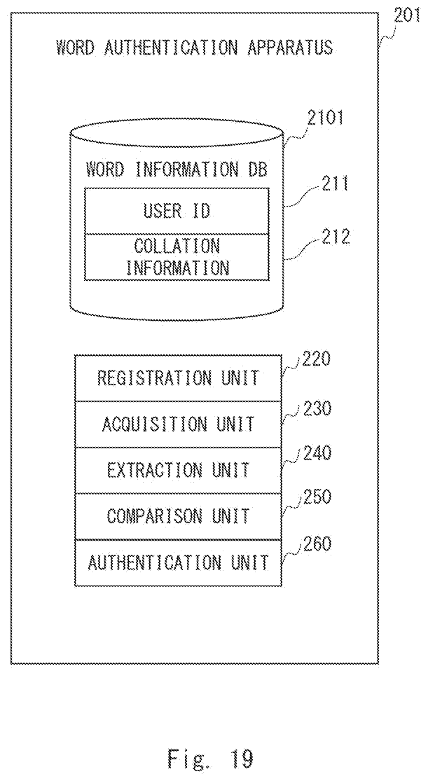

Next, a configuration of the word authentication apparatus 201 will be described. FIG. 19 is a block diagram showing a configuration of the word authentication apparatus 201 according to this example embodiment. The word authentication apparatus 201 includes a word information DB 2101, a registration unit 220, an acquisition unit 230, an extraction unit 240, a comparison unit 250, and an authentication unit 260.

The word information DB 2101 stores a user ID 211 and collation information 212 in association with each other.

The user ID 211 is identification information for identifying the user. The user ID 211 corresponds to the user ID 111 of the biometric information DB 110.

The collation information 212 indicates word information registered in advance by the user U. The collation information 212 may include a plurality of pieces of word information.

The registration unit 220 newly issues the user ID 211 when registering the collation information 212. The registration unit 220 registers the issued user ID 211 and the collation information 212 in the word information DB 2101 in association with each other.

The acquisition unit 230 corresponds to the acquisition unit 21 in the third example embodiment. The acquisition unit 230 acquires the voice of the user U who has succeeded in the voiceprint authentication in the biometric authentication apparatus 100 from the authentication terminal 400.

The extraction unit 240 corresponds to the extraction unit 22 in the third example embodiment. The extraction unit 240 extracts word information included in the acquired voice. The extraction unit 240 can extract word information by using a known voice recognition technology.

The comparison unit 250 corresponds to the comparison unit 23 in the third example embodiment. The comparison unit 250 compares the collation information 212 registered in advance with the word information extracted by extraction unit 240. The comparison unit 250 compares the collation information 212 with the state information a plurality of times, and counts the number of times of matching. The comparison unit 250 may perform the comparison according to order information included in the collation information 212. The order information is information indicating the order of each word.

The authentication unit 260 corresponds to the authentication unit 24 in the third example embodiment. The authentication unit 260 performs personal authentication of the user U on the basis of a plurality of comparison results in the comparison unit 250. The authentication unit 260 determines that the personal authentication has succeeded in a case where the number of times of matching between the collation information 212 and the word information is equal to or greater larger a threshold value.

The threshold value used for the determination of the state authentication may be set by the user U or may be set in correspondence with the number of the registered collation information 212. For example, a predetermined ratio (for example, 30%) of a plurality of pieces of the collation information 212 may be used as the threshold value.

The threshold value may be set in correspondence with a determination condition of the voiceprint authentication. For example, the threshold value is set to decrease as the determination condition of the voiceprint authentication becomes stricter. Since the severity of the determination condition is similar to the severity of the determination condition of the face authentication described in the second example embodiment, description thereof will be omitted.

### (Collation Information Registration Processing)

The registration processing of the collation information 212 is similar to that described with reference to the flowchart illustrated in FIG. 8, and thus detailed description thereof is omitted. As a result of the registration processing, the registration unit 220 issues the user ID 211, and registers the user ID 211 and the word information in the word information DB 2101 in association with each other.

In the second example embodiment, description has been given of a method in which the contents of the state master are shown to the user U as the candidates of the state information to be registered, and the collation information 212 is registered by receiving the selection of the user U. In this example embodiment, similarly to the second example embodiment, a word to be a registration candidate may be shown and selected from the user U, or the user U may register any word. For example, the word authentication apparatus 201 may receive a voice input of the user U from the authentication terminal 400 or the like, and register a word detected by using a known voice recognition technology. In addition, the word authentication apparatus 201 may receive a character input from the user U and register the input word. Note that, the number of words may be a predetermined number or more of characters.

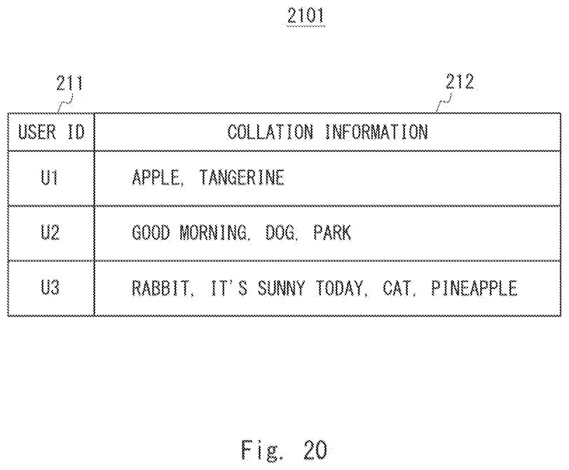

FIG. 20 is a view showing an example of contents stored in the word information DB 2101. As shown in the drawing, the number of the registered collation information 212 may be different depending on the user. Note that, in a case where the collation order is taken into consideration, a plurality of the same word contents may be registered. For example, a plurality of “apples” may be registered.

Furthermore, the registration unit 220 may receive an input from the user U and set a threshold value used for determination of word authentication. Since the setting of the threshold value is similar to that of the second example embodiment, description thereof is omitted. Note that, the registration unit 220 may set the threshold value in correspondence with the number of registered words, the small number of characters, or the like. The registration unit 220 may determine whether or not a person other than the user U is highly likely to correctly answer in consideration of, for example, the number of words, the number of characters, whether or not the word is a general word, or the like, and set the threshold value in correspondence with the determination result. Similarly to the second example embodiment, the registration unit 220 may cause the user U to select whether or not to consider the authentication order of the registered word information.

### (Word Authentication Processing)

Next, word authentication processing according to this example embodiment will be described.

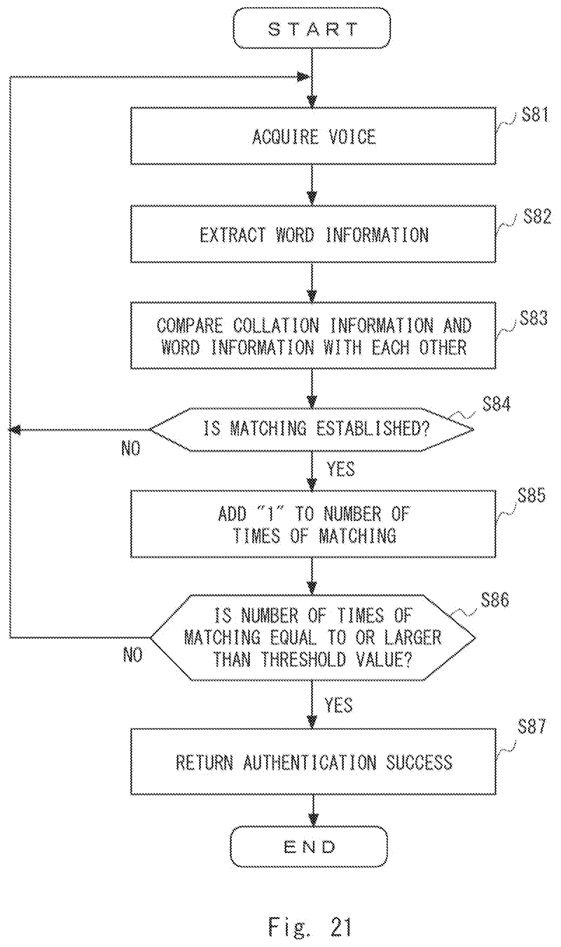

FIG. 21 is a flowchart illustrating a flow of word authentication processing according to this example embodiment. The word authentication apparatus 201 receives a word authentication request from the authentication terminal 400 and initiates word authentication processing. The word authentication request includes the user ID 111 specified by the biometric authentication apparatus 100.

First, the acquisition unit 230 acquires a voice of the user U from the authentication terminal 400 (S81). The extraction unit 240 extracts word information from the voice (S82). The comparison unit 250 compares the collation information 212 registered in advance with the extracted voice information (S83).

The comparison unit 250 determines whether or not the collation information 212 and the word information match each other (S84). For example, it is assumed that the extraction unit 240 extracts a word “apple”. The comparison unit 250 refers to the collation information 212 and confirms whether or not the word “apple” is registered in the collation information 212 of the user U. In a case where “apple” is registered, the comparison unit 250 determines that the collation information 212 and the word information match each other.

In a case where the collation information 212 and the word information do not match each other (NO in S84), the process returns to step S81. In a case where collation information 212 and the word information match each other (YES in S84), the comparison unit 250 adds “1” to the number of times of matching (S85). Note that, an initial value of the number of times of matching is 0 at the start of the present processing. In a case where the authentication order is taken into consideration, the comparison unit 250 performs determination including whether or not the order of the extracted word information matches registered contents.

The authentication unit 260 determines whether or not the number of times of matching is equal to or larger than a threshold value (S86). In a case where the number of times of matching is less than the threshold value (NO in S86), the process returns to step S81. In a case where the number of times of matching is equal to or larger than the threshold value (YES in S86), the authentication unit 260 returns the fact that the word authentication has succeeded to the authentication terminal 400 (S87).

Note that, also in this example embodiment, the display screen as described with reference to FIG. 12 and FIG. 13 may be displayed on the display unit 440 to perform the word authentication processing. For example, “the voiceprint authentication has succeeded. Next, please say the word registered in advance.”, “word is recognized. Please say the following words.”, “personal authentication has succeeded.”, and the like may be displayed.

### (Authentication Terminal 400)

The authentication terminal 400 is similar to that described by using the block diagram shown in FIG. 14. As shown in the same drawing, the authentication terminal 400 includes the sensor 410, the storage unit 420, the communication unit 430, the display unit 440, and the control unit 450.

In this example embodiment, the sensor 410 is a microphone that collects user's voice. The sensor 410 acquires a voice used in the voiceprint authentication and a voice used in the word authentication. Other configurations can be described by replacing the functions related to the face authentication and the state authentication described in the second example embodiment with the functions related to the voiceprint authentication and the word authentication. Therefore, detailed description of each functional unit will be omitted.

In the above description, the word authentication is performed after the voiceprint authentication is performed, but the present disclosure is not limited thereto. The voiceprint authentication and the first comparison in the word authentication may be performed simultaneously. For example, before performing the voiceprint authentication, the registration unit 220 causes the display unit 440 to display a message to prompt the user U to utter the registered word. In a case where the user U utters “apple”, the voiceprint authentication may be performed on the basis of the acquired voice, and in a case where the voiceprint authentication is successful, the word authentication may be performed by using the word “apple”. As a result, the first comparison in the voiceprint authentication and the word authentication can be performed at the same time, and thus the number of comparisons in the word authentication can be reduced.

As described above, the word authentication apparatus 201 according to this example embodiment can achieve similar effects as in the second example embodiment.

Note that, the configuration of the authentication system 1001 shown with reference to FIG. 18 is merely an example. Each of the biometric authentication apparatus 100, the word authentication apparatus 201, and the authentication terminal 400 may be configured by using an apparatus in which a plurality of configurations is integrated, or respective functional units may be subjected to distributed processing by using a plurality of apparatuses. Furthermore, similarly to the state authentication apparatus 200-2 described with reference to FIG. 15, the word authentication apparatus 201 according to this example embodiment may include the sensor 410-2 and the display unit 440-2. In addition, the word authentication apparatus 201 may be configured to further include the function of the biometric authentication apparatus 100.

### Fifth Example Embodiment

Next, a fifth example embodiment according to the present disclosure will be described.

In the first to fourth example embodiments, the personal authentication of the user U is performed by using the information relating to the face region of the user U or the information relating to the voice of the user U. In the fifth example embodiment, personal authentication of the user U is performed by using information relating to a fingerprint of the user U.

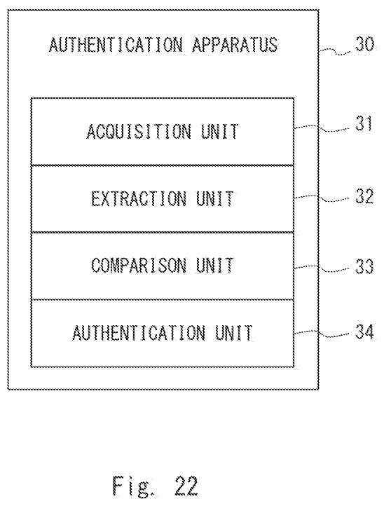

FIG. 22 is a block diagram showing a configuration of an authentication apparatus 30 according to this example embodiment.

The authentication apparatus 30 includes an acquisition unit 31, an extraction unit 32, a comparison unit 33, and an authentication unit 34.

The acquisition unit 31 acquires second fingerprint information of a user who has succeeded in fingerprint authentication using first fingerprint information. The extraction unit 32 extracts finger information indicated by the second fingerprint information. The finger information is information indicating that the first or second fingerprint information relates to which finger of the user. The finger information is, for example, “right hand index finger”, “right hand middle finger”, or the like. The comparison unit 33 compares collation information registered in advance with the finger information. The authentication unit 34 performs personal authentication of the user on the basis of a result of the comparison.

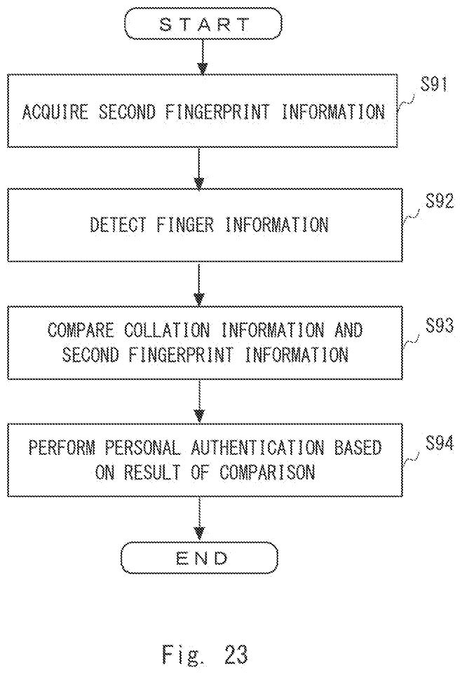

FIG. 23 is a flowchart illustrating finger authentication processing performed by the authentication apparatus 30. The finger authentication processing is authentication using the finger information acquired from the user who is a person to be authenticated.

First, the acquisition unit 31 acquires the second fingerprint information of the user who has succeeded in the fingerprint authentication (S91). The extraction unit 32 extracts finger information indicated by the second fingerprint information (S92). For example, the extraction unit 32 makes a request for the authentication apparatus that has performed the fingerprint authentication to perform second fingerprint authentication using the second fingerprint information, and acquires the fact that the second fingerprint authentication has succeeded and the finger information indicated by the second fingerprint information to extract the finger information.

The comparison unit 33 compares the collation information with the finger information (S93). The collation information is information for collation which is registered in advance in the authentication apparatus 30 by the user. The authentication unit 24 performs personal authentication of the user on the basis of a result of the comparison (S94). In a case where the collation information and the finger information match each other by a predetermined amount or more, the authentication unit 24 determines that the user has succeeded in personal authentication.

As described above, the authentication apparatus 30 according to this example embodiment acquires the second fingerprint information of the user who has succeeded in the fingerprint authentication, and extracts the finger information indicated by the second fingerprint information. The authentication apparatus 30 compares the collation information with the finger information to perform personal authentication of the user. In this way, it is possible to appropriately perform the personal authentication of the user who has succeeded in the fingerprint authentication.

### Sixth Example Embodiment

Next, a sixth example embodiment according to the present disclosure will be described. This example embodiment is a specific example of the fifth example embodiment.

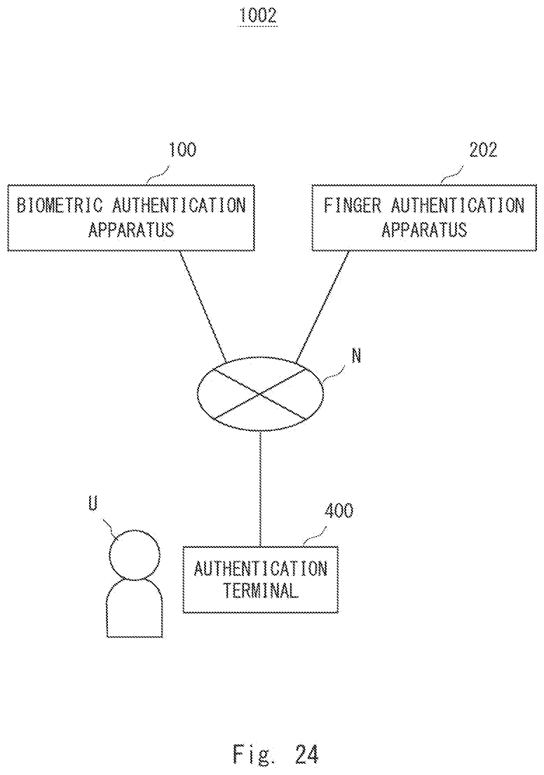

FIG. 24 is a block diagram illustrating a configuration of an authentication system 1002 according to this example embodiment. Note that, description of contents overlapping with the second and fourth example embodiments already described may be omitted. Hereinafter, differences from the second and fourth example embodiments will be mainly described.

### (Outline of Authentication System 1002)

The authentication system 1002 includes a biometric authentication apparatus 100, a finger authentication apparatus 202, and an authentication terminal 400. The biometric authentication apparatus 100, the finger authentication apparatus 202, and the authentication terminal 400 are connected through the network N.

The authentication system 1002 acquires a fingerprint of the user U who is a person to be authenticated in the authentication terminal 400, and performs personal authentication of the user U by using the biometric authentication apparatus 100 and the finger authentication apparatus 202 on the basis of information extracted from the fingerprint. Since an installation place and the like of the authentication terminal 400 are similar to those of the authentication system 1000 described in the second example embodiment, detailed description thereof will be omitted.

First, the authentication terminal 400 makes a request for the biometric authentication apparatus 100 to perform fingerprint authentication, and receives a result of the fingerprint authentication from the biometric authentication apparatus 100. In a case where the fingerprint authentication has succeeded, the authentication terminal 400 subsequently makes a request for the finger authentication apparatus 202 to perform finger authentication, and receives a result of the finger authentication from the finger authentication apparatus 202.

In a case where the user U has also succeeded in the finger authentication, the authentication terminal 400 determines that the user U has succeeded in the personal authentication.

### (Biometric Authentication Apparatus 100)

Next, a configuration of the biometric authentication apparatus 100 will be described.

In the second and fourth example embodiments, the biometric authentication apparatus 100 performs the face authentication or the voiceprint authentication as the biometric authentication. In this example embodiment, the biometric authentication apparatus 100 performs fingerprint authentication instead of the face authentication and the voiceprint authentication. The biometric authentication apparatus 100 performs the fingerprint authentication of the user U by using fingerprint feature information of the user U as the biometric information. The biometric authentication apparatus 100 receives the fingerprint authentication request in combination with the fingerprint of the user U from the authentication terminal 400, performs the fingerprint authentication of the user U, and returns the result to the authentication terminal 400.

The configuration of the biometric authentication apparatus 100 is similar to that described in the second example embodiment with reference to FIG. 4. As illustrated in FIG. 4, the biometric authentication apparatus 100 includes the biometric information DB 110, the detection unit 120, the feature point extraction unit 130, the registration unit 140, and the authentication unit 150. The configuration of each functional unit can be described by replacing the facial feature information in the second example embodiment with the fingerprint feature information, and thus the detailed description thereof is omitted here.

When collation is successful, the authentication unit 150 specifies the user ID 111 associated with the collated biometric feature information 112 and specifies that the fingerprint used for the authentication is a fingerprint of which finger.

### (Fingerprint Information Registration Processing)

In this example embodiment, the fingerprint feature information of the user U is registered as the biometric information. The flow of the registration processing is similar to the facial feature information registration processing described with reference to the flowchart shown in FIG. 5. Hereinafter, the flow of the registration processing will be described in a simplified manner by appropriately replacing the contents with reference to FIG. 5.

The biometric authentication apparatus 100 acquires an image including a fingerprint of the user from the authentication terminal 400 or the like (S21). Next, the detection unit 120 detects the fingerprint from the acquired image or the like (S22). Then, the feature point extraction unit 130 extracts fingerprint feature information from the fingerprint (S23). Finally, the registration unit 140 registers the user ID 111 and the biometric feature information (fingerprint feature information) 112 in the biometric information DB 110 in association with each other (S24).

### (Fingerprint Authentication Processing)

In this example embodiment, fingerprint authentication is performed as biometric authentication processing. The flow of the biometric authentication processing is similar to the face authentication processing described with reference to the flowchart shown in FIG. 6. Since the biometric authentication processing can be described by replacing the facial feature information in the second example embodiment with the fingerprint feature information, detailed description thereof will be omitted here.

### (Finger Authentication Apparatus 202)

Referring back to FIG. 24, the finger authentication apparatus 202 will be described. The finger authentication apparatus 202 is an example of the authentication apparatus 30 in the fifth example embodiment.

The finger authentication apparatus 202 is an information processing apparatus that collates finger information included in the request with collation information of each user U in response to the finger authentication request received from the outside, and returns a collation result (authentication result) to a request source. In this example embodiment, the finger authentication apparatus 202 receives the finger authentication request with respect to the user U who has succeeded in the fingerprint authentication from the authentication terminal 400. The finger authentication apparatus 202 performs finger authentication with respect to the user U and returns a result of the finger authentication to the authentication terminal 400.

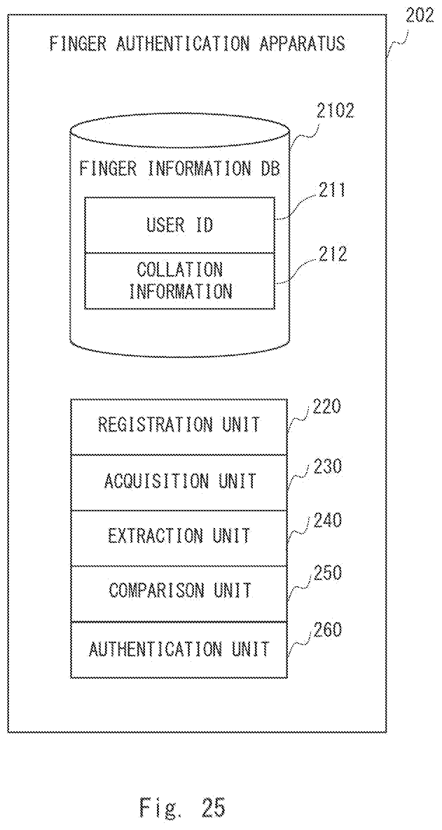

Next, a configuration of the finger authentication apparatus 202 will be described. FIG. 25 is a block diagram showing a configuration of the finger authentication apparatus 202 according to this example embodiment. The finger authentication apparatus 202 includes a finger information DB 2102, a registration unit 220, an acquisition unit 230, an extraction unit 240, a comparison unit 250, and an authentication unit 260.

The finger information DB 2102 stores a user ID 211 and collation information 212 in association with each other.

The user ID 211 is identification information for identifying the user. The user ID 211 corresponds to the user ID 111 of the biometric information DB 110.

The collation information 212 indicates finger information registered in advance by the user U. The collation information 212 may include a plurality of pieces of finger information.

The registration unit 220 newly issues the user ID 211 when registering the collation information 212. The registration unit 220 registers the issued user ID 211 and the collation information 212 in the finger information DB 2102 in association with each other.

The acquisition unit 230 corresponds to the acquisition unit 31 in the fifth example embodiment. The acquisition unit 230 acquires second fingerprint information of the user U who has succeeded in fingerprint authentication using first fingerprint information in the biometric authentication apparatus 100 from the authentication terminal 400.

The extraction unit 240 corresponds to the extraction unit 32 in the fifth example embodiment. The extraction unit 240 extracts finger information indicated by the second fingerprint information. The finger information is information indicating that the first or second fingerprint information relates to which finger of the user. The finger information is, for example, “right hand index finger”, “right hand middle finger”, or the like.

The comparison unit 250 corresponds to the comparison unit 33 in the fifth example embodiment. The comparison unit 250 compares collation information 212 registered in advance with the finger information. The comparison unit 250 compares the collation information 212 with the state information a plurality of times, and counts the number of times of matching. The comparison unit 250 may perform the comparison according to order information included in the collation information 212. The order information is information indicating the order of each finger.

The authentication unit 260 corresponds to the authentication unit 34 in the fifth example embodiment. The authentication unit 260 performs personal authentication of the user U on the basis of a plurality of comparison results in the comparison unit 250. The authentication unit 260 determines that the personal authentication has succeeded in a case where the number of times of matching between the collation information 212 and the finger information is equal to or larger than a threshold value.

The threshold value used for the determination of the state authentication may be set by the user U or may be set in correspondence with the number of the registered collation information 212. For example, a predetermined ratio (for example, 30%) of a plurality of pieces of the collation information 212 may be used as the threshold value.

The threshold value may be set in correspondence with a determination condition of the fingerprint authentication. For example, the threshold value is set to decrease as the determination condition of the finger authentication becomes stricter. Since the severity of the determination condition is similar to the severity of the determination condition of the face authentication described in the second example embodiment, description thereof will be omitted.

### (Collation Information Registration Processing)

The registration processing of the collation information 212 is similar to that described with reference to the flowchart illustrated in FIG. 8, and thus detailed description thereof is omitted. As a result of the registration processing, the registration unit 220 issues the user ID 211, and registers the user ID 211 and the finger information in the finger information DB 2102 in association with each other.

The finger authentication apparatus 202 can receive an input of a fingerprint of the user U from the authentication terminal 400, a communication terminal of the user U, or the like, and register a fingerprint detected using a known fingerprint authentication technology as the collation information 212. Note that, the number of fingerprints to be registered may be a predetermined number or more.

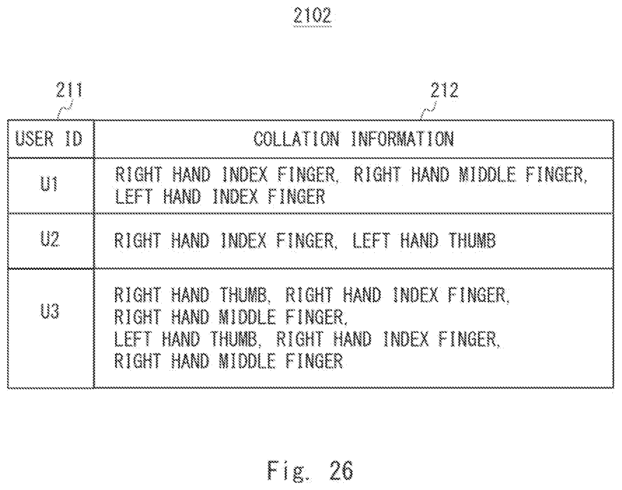

FIG. 26 is a view showing an example of contents stored in the finger information DB 2102. As shown in the drawing, the number of the registered collation information 212 may be different depending on the user. Furthermore, the registration unit 220 sets a threshold value used for determination of finger authentication. The registration unit 220 may set the threshold value by receiving an input from the user U, calculating the threshold value in correspondence with the number of the registered collation information 212, or the like. For example, the registration unit 220 sets a predetermined ratio (for example, 50%) of the collation information 212 as a threshold value. Since the setting of the threshold value is similar to that of the second example embodiment, description thereof is omitted.

For example, in the example of FIG. 26, the user U1 registers in advance “right hand index finger”, “right hand middle finger”, and “left hand index finger”. In a case where the threshold value is 50%, it is determined that the finger authentication is successful when two pieces of finger information that are 50% or more among the three pieces of finger information match. Note that, one of a plurality of pieces of the finger information included in collation information 212 may be the finger information detected from the first fingerprint information. That is, the comparison unit 250 can count the success of the fingerprint authentication using the first fingerprint information as the number of times of matching. For example, when the user U1 succeeds in the fingerprint authentication using the “right hand index finger” as the first fingerprint information, the user U1 succeeds in the finger authentication using the “right hand middle finger” or the “left hand index finger”, thereby succeeding in the personal authentication.

Similarly to the second example embodiment, the registration unit 220 may cause the user U to select whether or not to consider the authentication order of the second fingerprint information Note that, in a case where the authentication order is taken into consideration, a plurality of the same fingerprints may be registered. For example, a plurality of “right hand index finger” may be registered.

### (Finger Authentication Processing)

Next, finger authentication processing according to this example embodiment will be described.

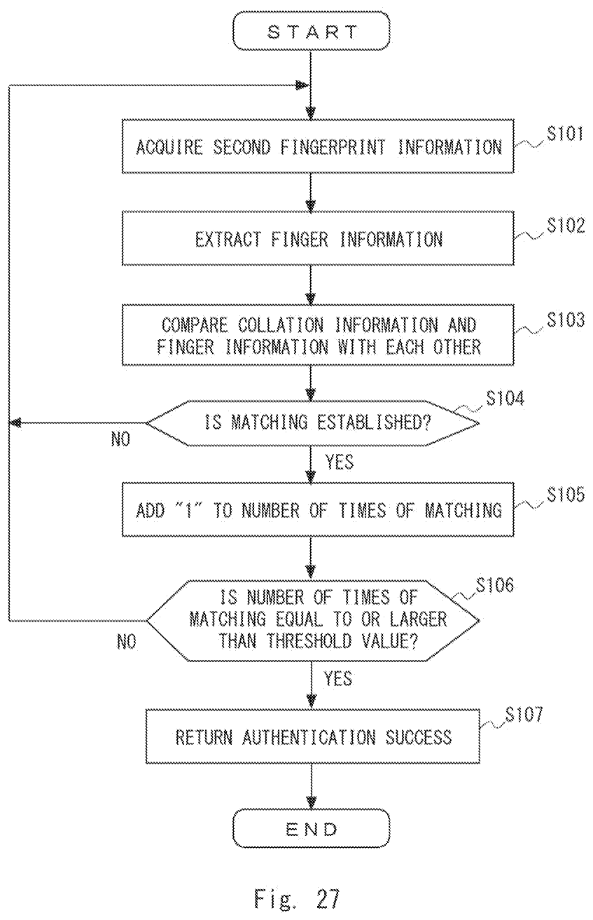

FIG. 27 is a flowchart illustrating a flow of finger authentication processing according to this example embodiment. The finger authentication apparatus 202 receives a finger authentication request from the authentication terminal 400 and initiates finger authentication processing. The finger authentication request includes the user ID 111 specified in the finger authentication by the biometric authentication apparatus 100. Further, the finger authentication request may include finger information of the finger used in the fingerprint authentication. The comparison unit 250 can confirm that the finger information exists in the collation information 212, add “1” to the number of times of matching in advance, and initiate the present processing.

First, the acquisition unit 230 acquires the second fingerprint information from the authentication terminal 400 (S101). The extraction unit 240 extracts finger information indicated by the second fingerprint information (S102). For example, the extraction unit 240 makes a request for the biometric authentication apparatus 100 to perform the second fingerprint authentication using the second fingerprint information. The extraction unit 240 acquires the fact that the second fingerprint authentication is successful, and the finger information indicated by the second fingerprint information from the biometric authentication apparatus 100.

The comparison unit 250 compares collation information 212 registered in advance with the finger information (S103). For example, it is assumed that finger information “right hand index finger” is extracted in the extraction unit 240. The comparison unit 250 refers to the collation information 212 and confirms whether or not the “right hand index finger” is registered in the collation information 212 of the user U (S104). In a case where the “right hand index finger” is registered, the comparison unit 250 determines that the collation information 212 and the word information match each other.

In a case where the collation information 212 and the finger information do not match each other (NO in S104), the process returns to step S101. In a case where collation information 212 and the finger information match each other (YES in S104), the comparison unit 250 adds “1” to the number of times of matching (S105). In a case where the authentication order is taken into consideration, the comparison unit 250 performs determination including whether or not the order of the extracted finger information matches registered contents.

The authentication unit 260 determines whether or not the number of times of matching is equal to or larger than a threshold value (S106). In a case where the number of times of matching is less than the threshold value (NO in S106), the process returns to step S101. In a case where the number of times of matching is equal to or larger than the threshold value (YES in S106), the authentication unit 260 returns the fact that the finger authentication has succeeded to the authentication terminal 400 (S107).

Note that, also in this example embodiment, the display screen as described with reference to FIG. 12 and FIG. 13 may be displayed on the display unit 440 to perform the index authentication processing. For example, “the fingerprint authentication has succeeded. Next, please perform fingerprint authentication with another finger registered in advance.”, “fingerprint is recognized. please input next fingerprint.”, “personal authentication has succeeded.”, and the like may be displayed.

### (Authentication Terminal 400)

The authentication terminal 400 is similar to that described by using the block diagram shown in FIG. 14. As shown in the same drawing, the authentication terminal 400 includes the sensor 410, the storage unit 420, the communication unit 430, the display unit 440, and the control unit 450.

In this example embodiment, the sensor 410 is a fingerprint sensor that detects user's fingerprint. The fingerprint sensor may be any type such as an optical type, a capacitive type, and an ultrasonic type. The sensor 410 acquires first fingerprint information and second fingerprint information. Other configurations can be described by replacing the functions related to the face authentication and the state authentication described in the second example embodiment with the functions related to the fingerprint authentication and the finger authentication. Therefore, detailed description of each functional unit will be omitted.

As described above, the finger authentication apparatus 202 according to this example embodiment can achieve similar effects as in the second example embodiment.

Note that, the configuration of the authentication system 1002 shown with reference to FIG. 24 is merely an example. Each of the biometric authentication apparatus 100, the finger authentication apparatus 202, and the authentication terminal 400 may be configured by using an apparatus in which a plurality of configurations is integrated, or respective functional units may be subjected to distributed processing by using a plurality of apparatuses. Furthermore, similarly to the state authentication apparatus 200-2 described with reference to FIG. 15, the finger authentication apparatus 202 according to this example embodiment may include the sensor 410-2 and the display unit 440-2. In addition, the finger authentication apparatus 202 may be configured to further include the function of the biometric authentication apparatus 100.

### Seventh Example Embodiment

Next, a seventh example embodiment according to the present disclosure will be described. This example embodiment represents a concept common to the above-described example embodiments.

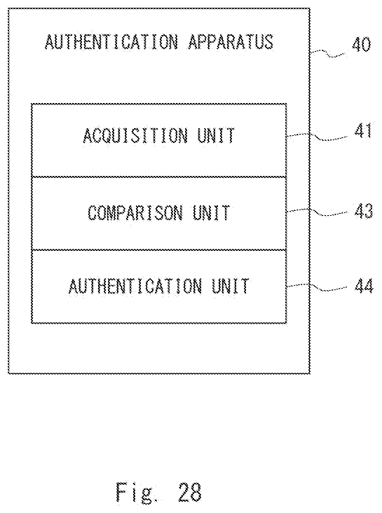

FIG. 28 is a block diagram showing a configuration of an authentication apparatus 40 according to this example embodiment.

The authentication apparatus 40 includes an acquisition unit 41, a comparison unit 43, and an authentication unit 44.

The acquisition unit 41 acquires authentication information that is second biometric information of a user who has succeeded in biometric authentication using first biometric information, and is second biometric information that can be acquired by an instrument that has acquired the first biometric information. The comparison unit 43 compares collation information registered in advance with authentication information. The authentication unit 44 performs personal authentication of the user on the basis of a result of the comparison.

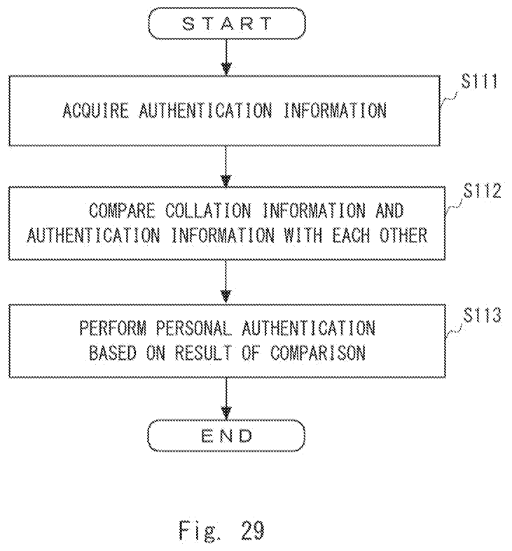

FIG. 29 is a flowchart illustrating authentication processing performed by the authentication apparatus 40. First, the acquisition unit 41 acquires the authentication information (S111). For example, it is assumed that the user succeeds in the face authentication (biometric authentication) by using the facial feature information (first biometric information) acquired by the camera (instrument). The acquisition unit 41 acquires state information (second biometric information), which is second biometric information that can be acquired by the camera, as authentication information. Since the state information is similar to that described in the first and second example embodiments, detailed description thereof will be omitted.

The comparison unit 43 compares the collation information with the authentication information (S112). The collation information is information for collation which is registered in advance in the authentication apparatus 40 by the user. The authentication unit 44 performs personal authentication of the user on the basis of a result of the comparison (S113). In a case where the collation information and the authentication information match each other by a predetermined amount or more, the authentication unit 44 determines that the user has succeeded in personal authentication.

As described above, according to the authentication apparatus 40 of this example embodiment, the authentication information that is the second biometric information that can be acquired by the instrument that has acquired the first biometric information of the user is acquired, and the collation information is compared with the authentication information to perform the personal authentication of the user. In this way, it is possible to appropriately perform the personal authentication of the user who has succeeded in the biometric authentication using the first biometric information.

Note that, the first biometric information and second biometric information are not limited to information relating to the user's face. As described with reference to the third example embodiment to the sixth example embodiment, the first biometric information and second biometric information may be information relating to a voiceprint or a fingerprint of the user. In addition, the instrument that acquires the first biometric information and second biological information is not limited to the camera, and a microphone, a fingerprint sensor, or the like may be used in correspondence with the biological information.

With such a configuration, the authentication accuracy can be improved without preparing a plurality of authentication instruments such as a face authentication instrument (camera) and a voiceprint authentication instrument (microphone). In addition, since the authentication rate can be closer to 100%, authentication equivalent to two-factor authentication can be realized. Therefore, it is possible to appropriately perform personal authentication even in payment and the like in which strict personal authentication is required.

### <Configuration Example of Hardware>

Each functional component of the biometric authentication apparatus 100, the authentication apparatuses 10 to 40, the state authentication apparatus 200, the word authentication apparatus 201, the finger authentication apparatus 202, and the authentication terminal 400 may be realized by hardware (for example, a hard-wired electronic circuit or the like) that realizes each functional component, or may be realized by a combination of hardware and software (for example, a combination of an electronic circuit and a program that controls the electronic circuit or the like). Hereinafter, a case where each functional configuration unit of the state authentication apparatus 200 and the like is realized by a combination of hardware and software will be further described.

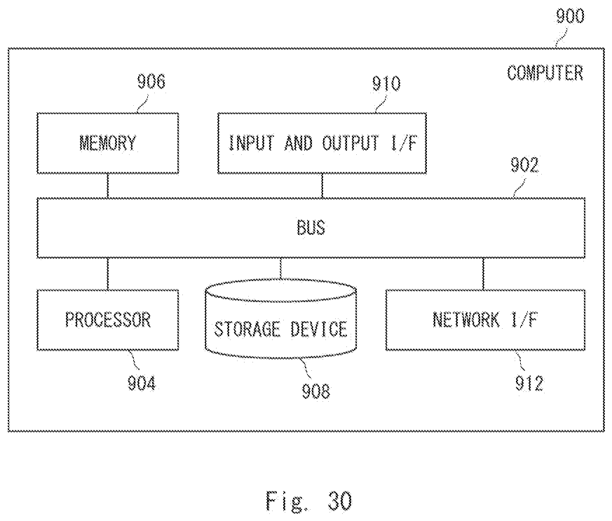

FIG. 30 is a block diagram illustrating a hardware configuration of a computer 900 that realizes the state authentication apparatus 200 and the like. The computer 900 may be a dedicated computer designed to realize the state authentication apparatus 200 and the like, or may be a general-purpose computer. The computer 900 may be a portable computer such as a smartphone and a tablet terminal.

For example, when a predetermined application is installed in the computer 900, each function of the state authentication apparatus 200 and the like is realized in the computer 900. The application is configured by a program for realizing a functional configuration unit of the state authentication apparatus 200 and the like.

The computer 900 includes a bus 902, a processor 904, a memory 906, a storage device 908, an input/output interface 910, and a network interface 912. The bus 902 is a data transmission path for the processor 904, the memory 906, the storage device 908, the input/output interface 910, and the network interface 912 to transmit and receive data to and from each other. However, a method of connecting the processor 904 and the like to each other is not limited to the bus connection.

The processor 904 is a variety of processors such as a central processing unit (CPU), a graphics processing unit (GPU), and a field-programmable gate array (FPGA). The memory 906 is a main storage apparatus realized by using a random access memory (RAM) or the like. The storage device 908 is an auxiliary storage apparatus realized by using a hard disk, a solid state drive (SSD), a memory card, a read only memory (ROM), or the like.

The input/output interface 910 is an interface for connecting the computer 900 and an input/output device. For example, an input apparatus such as a keyboard and an output apparatus such as a display apparatus are connected to the input/output interface 910.

The network interface 912 is an interface for connecting the computer 900 to a network. The network may be a local area network (LAN) or may be a wide area network (WAN).

The storage device 908 stores a program (program for realizing the above-described application) for realizing each functional configuration unit of the state authentication apparatus 200 and the like. The processor 904 realizes each functional configuration unit of the state authentication apparatus 200 and the like by reading and executing this program in the memory 906.

Each of the processors executes one or more programs including a command group for causing a computer to perform the algorithm described with reference to the drawings. The program includes a command group (or software codes) for causing the computer to perform one or more functions that have been described in the example embodiments when the program is read by the computer. The program may be stored in a non-transitory computer-readable medium or a tangible storage medium. As an example and not by way of limitation, the computer-readable medium or the tangible storage medium includes a random-access memory (RAM), a read-only memory (ROM), a flash memory, a solid-state drive (SSD) or any other memory technology, a CD-ROM, a digital versatile disc (DVD), a Blu-ray (registered trademark) disc or any other optical disk storage, a magnetic cassette, a magnetic tape, a magnetic disk storage, and any other magnetic storage device. The program may be transmitted on a transitory computer-readable medium or a communication medium. As an example and not by way of limitation, the transitory computer-readable medium or the communication medium includes propagated signals in electrical, optical, acoustic, or any other form.

Note that the present disclosure is not limited to the above example embodiments, and can be appropriately changed without departing from the scope and spirit

Some or all of the above-described example embodiments can be described as in the following Supplementary Notes, but are not limited to the following Supplementary Notes.

### (Supplementary Note A1)

An authentication apparatus, including:
acquisition means for acquiring authentication information that is second biometric information of a user who has succeeded in biometric authentication using first biometric information, and is second biometric information capable of being acquired by an instrument that has acquired the first biometric information;
comparison means for comparing collation information registered in advance with the authentication information; and
authentication means for performing personal authentication of the user on the basis of a result of the comparison.

### (Supplementary Note A2)

The authentication apparatus according to Supplementary Note A1,
wherein the authentication means performs the personal authentication on the basis of a plurality of the results of the comparison.

### (Supplementary Note A3)

The authentication apparatus according to Supplementary Note A2,
wherein the authentication means determines that the personal authentication has succeeded when the number of times of matching between the collation information and the authentication information is equal to or larger than a threshold value.

### (Supplementary Note A4)

The authentication apparatus according to Supplementary Note A3,
wherein the threshold value is set in correspondence with the number of the registered collation information.

### (Supplementary Note A5)

The authentication apparatus according to Supplementary Note A3 or A4,
wherein the threshold value is set in correspondence with a determination condition of the biometric authentication using the first biometric information.

### (Supplementary Note A6)

The authentication apparatus according to Supplementary Note A5,
wherein the threshold value is set to be smaller as the determination condition of the biometric authentication using the first biometric information becomes stricter.

### (Supplementary Note A7)

The authentication apparatus according to any one of Supplementary Notes A1 to A6,
wherein the collation information includes order information indicating an authentication order, and
the comparison means performs the comparison according to the order information.

### (Supplementary Note A8)

An authentication system, including:
an authentication terminal configured to acquire first biometric information of a user and control biometric authentication of the user; and
an authentication apparatus connected to the authentication terminal,
wherein the authentication apparatus includes,
acquisition means for acquiring authentication information that is second biometric information of the user who has succeeded in the biometric authentication and is second biometric information capable of being acquired by the authentication terminal,
comparison means for comparing collation information registered in advance with the authentication information, and
authentication means for performing personal authentication of the user on the basis of a result of the comparison.

### (Supplementary Note A9)

An authentication method, including:
acquiring authentication information that is second biometric information of a user who has succeeded in biometric authentication using first biometric information, and is second biometric information capable of being acquired by an instrument that has acquired the first biometric information;
comparing collation information registered in advance with the authentication information; and
performing personal authentication of the user on the basis of a result of the comparison.

### (Supplementary Note A10)

A non-transitory computer-readable medium that stores a program causing a computer to execute:
acquisition processing of acquiring authentication information that is second biometric information of a user who has succeeded in biometric authentication using first biometric information, and is second biometric information capable of being acquired by an instrument that has acquired the first biometric information;
comparison processing of comparing collation information registered in advance with the authentication information; and
authentication processing of performing personal authentication of the user on the basis of a result of the comparison.

### (Supplementary Note B1)

An authentication apparatus, including:
acquisition means for acquiring a face image including a face region of a user who has succeeded in face authentication;
extraction means for extracting state information indicating a state of the face region from the face image;
comparison means for comparing collation information registered in advance with the state information; and
authentication means for performing personal authentication of the user on the basis of a result of the comparison.

### (Supplementary Note B2)

The authentication apparatus according to Supplementary Note B1,
wherein the authentication means performs the personal authentication on the basis of a plurality of the results of the comparison.

### (Supplementary Note B3)

The authentication apparatus according to Supplementary Note B2,
wherein the authentication means determines that the personal authentication has succeeded when the number of times of matching between the collation information and the state information is equal to or larger than a threshold value.

### (Supplementary Note B4)

The authentication apparatus according to Supplementary Note B3,
wherein the threshold value is set in correspondence with the number of the registered collation information.

### (Supplementary Note B5)

The authentication apparatus according to Supplementary Note B3 or B4,
wherein the threshold value is set in correspondence with a determination condition of the face authentication.

### (Supplementary Note B6)

The authentication apparatus according to Supplementary Note B5,
wherein the threshold value is set to be smaller as the determination condition of the face authentication becomes stricter.

### (Supplementary Note B7)

The authentication apparatus according to any one of Supplementary Notes B1 to B6,
wherein the collation information includes order information indicating an authentication order, and
the comparison means performs the comparison according to the order information.

### (Supplementary Note B8)

The authentication apparatus according to any one of Supplementary Notes B1 to B7,
wherein the acquisition means includes a camera that images the user, and
the camera acquires the face image and an image used in the face authentication.

### (Supplementary Note B9)

An authentication system, including:
an authentication terminal configured to image a face region of a user and control face authentication of the user; and
an authentication apparatus connected to the authentication terminal,
wherein the authentication apparatus includes,
acquisition means for acquiring a face image including a face region of the user who has succeeded in face authentication,
extraction means for extracting state information indicating a state of the face region from the face image,
comparison means for comparing collation information registered in advance with the state information, and
authentication means for performing personal authentication of the user on the basis of a result of the comparison.

### (Supplementary Note B10)

The authentication system according to Supplementary Note B9,
wherein the authentication means performs the personal authentication on the basis of a plurality of the results of the comparison.

### (Supplementary Note B11)

An authentication method, including:
acquiring a face image including a face region of a user who has succeeded in face authentication;
extracting state information indicating a state of the face region from the face image;
comparing collation information registered in advance with the state information; and
performing personal authentication of the user on the basis of a result of the comparison.

### (Supplementary Note B12)

A non-transitory computer-readable medium that stores a program causing a computer to execute:
acquisition processing of acquiring a face image including a face region of a user who has succeeded in face authentication;
extraction processing of extracting state information indicating a state of the face region from the face image;
comparison processing of comparing collation information registered in advance with the state information; and
authentication processing of performing personal authentication of the user on the basis of a result of the comparison.

### (Supplementary Note C1)

An authentication apparatus, including:
acquisition means for acquiring a voice of a user who has succeeded in voiceprint authentication;
extraction means for extracting word information included in the voice;
comparison means for comparing collation information registered in advance with the word information; and
authentication means for performing personal authentication of the user on the basis of a result of the comparison.

### (Supplementary Note C2)

The authentication apparatus according to Supplementary Note C1,
wherein the authentication means performs the personal authentication on the basis of a plurality of the results of the comparison.

### (Supplementary Note C3)

The authentication apparatus according to Supplementary Note C2,
wherein the authentication means determines that the personal authentication has succeeded when the number of times of matching between the collation information and the word information is equal to or larger than a threshold value.

### (Supplementary Note C4)

The authentication apparatus according to Supplementary Note C3,
wherein the threshold value is set in correspondence with the number of the registered collation information.

### (Supplementary Note C5)

The authentication apparatus according to Supplementary Note C3 or C4,
wherein the threshold value is set in correspondence with a determination condition of the voiceprint authentication.

### (Supplementary Note C6)

The authentication apparatus according to Supplementary Note C5,
wherein the threshold value is set to be smaller as the determination condition of the voiceprint authentication becomes stricter.

### (Supplementary Note C7)

The authentication apparatus according to any one of Supplementary Notes C1 to C6,
wherein the collation information includes order information indicating an authentication order, and
the comparison means performs the comparison according to the order information.

### (Supplementary Note C8)

The authentication apparatus according to any one of Supplementary Notes C1 to C7,
wherein the acquisition means includes a microphone that collects the voice of the user, and
the microphone acquires the voice, and a voice that is used in the voiceprint authentication.

### (Supplementary Note C9)

An authentication system, including:
an authentication terminal configured to acquire a voice of a user and control voiceprint authentication of the user; and
an authentication apparatus connected to the authentication terminal,
wherein the authentication apparatus includes,
acquisition means for acquiring a voice of a user who has succeeded in the voiceprint authentication,
extraction means for extracting word information included in the voice,
comparison means for comparing collation information registered in advance with the word information, and
authentication means for performing personal authentication of the user on the basis of a result of the comparison.

### (Supplementary Note C10)

The authentication system according to Supplementary Note C9,
wherein the authentication means performs the personal authentication on the basis of a plurality of the results of the comparison.

### (Supplementary Note C11)

An authentication method, including:
acquiring a voice of a user who has succeeded in voiceprint authentication;
extracting word information included in the voice;
comparing collation information registered in advance with the word information; and
performing personal authentication of the user on the basis of a result of the comparison.

### (Supplementary Note C12)

A non-transitory computer-readable medium that stores a program causing a computer to execute:
acquisition processing of acquiring a voice of a user who has succeeded in voiceprint authentication;
extraction processing of extracting word information included in the voice;
comparison processing of comparing collation information registered in advance with the word information; and
authentication processing of performing personal authentication of the user on the basis of a result of the comparison.

### (Supplementary Note D1)

An authentication apparatus, including:
acquisition means for acquiring second fingerprint information of a user who has succeeded in fingerprint authentication using first fingerprint information;
extraction means for extracting finger information indicated by the second fingerprint information;
comparison means for comparing collation information registered in advance with the finger information; and
authentication means for performing personal authentication of the user on the basis of a result of the comparison.

### (Supplementary Note D2)

The authentication apparatus according to Supplementary Note D1,
wherein the authentication means performs the personal authentication on the basis of a plurality of the results of the comparison.

### (Supplementary Note D3)

The authentication apparatus according to Supplementary Note D2,
wherein the authentication means determines that the personal authentication has succeeded when the number of times of matching between the collation information and the finger information is equal to or larger than a threshold value.

### (Supplementary Note D4)

The authentication apparatus according to Supplementary Note D3,
wherein the threshold value is set in correspondence with the number of the registered collation information.

### (Supplementary Note D5)

The authentication apparatus according to Supplementary Note D3 or D4,
wherein the threshold value is set in correspondence with a determination condition of the fingerprint authentication.

### (Supplementary Note D6)

The authentication apparatus according to Supplementary Note D5,
wherein the threshold value is set to be smaller as the determination condition of the fingerprint authentication becomes stricter.

### (Supplementary Note D7)

The authentication apparatus according to any one of Supplementary Notes D1 to D6,
wherein the collation information includes order information indicating an authentication order, and
the comparison means performs the comparison according to the order information.

### (Supplementary Note D8)

The authentication apparatus according to any one of Supplementary Notes D1 to D7,
wherein the acquisition means includes a fingerprint sensor that acquires a fingerprint of the user, and
the fingerprint sensor acquires the first fingerprint information and the second fingerprint information.

### (Supplementary Note D9)

An authentication system, including:
an authentication terminal configured to acquire first fingerprint information of a user and control fingerprint authentication of the user; and
an authentication apparatus connected to the authentication terminal,
wherein the authentication apparatus includes,
acquisition means for acquiring second fingerprint information of the user who has succeeded in the fingerprint authentication,
extraction means for extracting finger information indicated by the second fingerprint information,
comparison means for comparing collation information registered in advance with the finger information, and
authentication means for performing personal authentication of the user on the basis of a result of the comparison.

### (Supplementary Note D10)

The authentication system according to Supplementary Note D9,
wherein the authentication means performs the personal authentication on the basis of a plurality of the results of the comparison.

### (Supplementary Note D11)

An authentication method, including:
acquiring second fingerprint information of a user who has succeeded in fingerprint authentication using first fingerprint information;
extracting finger information indicated by the second fingerprint information;
comparing collation information registered in advance with the finger information; and
performing personal authentication of the user on the basis of a result of the comparison.

### (Supplementary Note D12)

A non-transitory computer-readable medium that stores a program causing a computer to execute:
acquisition processing of acquiring second fingerprint information of a user who has succeeded in fingerprint authentication using first fingerprint information;
extraction processing of extracting finger information indicated by the second fingerprint information;
comparison processing of comparing collation information registered in advance with the finger information; and
authentication processing of performing personal authentication of the user on the basis of a result of the comparison.

### REFERENCE SIGNS LIST

10, 20, 30, 40 AUTHENTICATION APPARATUS
11, 21, 31, 41 ACQUISITION UNIT
12, 22, 32 EXTRACTION UNIT
13, 23, 33, 43 COMPARISON UNIT
14, 24, 34, 44 AUTHENTICATION UNIT
100 BIOMETRIC AUTHENTICATION APPARATUS
110 BIOMETRIC INFORMATION DB
111, 211 USER ID
112 BIOMETRIC FEATURE INFORMATION
120 DETECTION UNIT
130 FEATURE POINT EXTRACTION UNIT
140 REGISTRATION UNIT
150 AUTHENTICATION UNIT
200, 200-2 STATE AUTHENTICATION APPARATUS
201 WORD AUTHENTICATION APPARATUS
202 FINGER AUTHENTICATION APPARATUS
210 STATE INFORMATION DB
2101 WORD INFORMATION DB
2102 FINGER INFORMATION DB
212 COLLATION INFORMATION
220 REGISTRATION UNIT
230 ACQUISITION UNIT
240 EXTRACTION UNIT
250 COMPARISON UNIT
260 AUTHENTICATION UNIT
400 AUTHENTICATION TERMINAL
410, 410-2 SENSOR
420 STORAGE UNIT
430 COMMUNICATION UNIT
440, 440-2 DISPLAY UNIT
440a, 440b DISPLAY SCREEN
450 CONTROL UNIT
451 DETECTION CONTROL UNIT
452 REGISTRATION UNIT
453 AUTHENTICATION CONTROL UNIT
454 DISPLAY CONTROL UNIT
900 COMPUTER
902 BUS
904 PROCESSOR
906 MEMORY
908 STORAGE DEVICE
910 INPUT/OUTPUT INTERFACE
912 NETWORK INTERFACE
1000, 1001, 1002 AUTHENTICATION SYSTEM
N NETWORK
U, U1, U2 USER

What is claimed is:

1. An authentication apparatus comprising:
at least one memory storing instructions; and
at least one processor configured to execute the instructions to:
acquire authentication information that is second biometric information of a user who has succeeded in biometric authentication using first biometric information, and is second biometric information capable of being acquired by an instrument that has acquired the first biometric information;
compare collation information registered in advance with the authentication information; and
perform personal authentication of the user on the basis of a result of the comparison.

2. The authentication apparatus according to claim 1, wherein the at least one processor is further configured to execute the instructions to perform the personal authentication on the basis of a plurality of the results of the comparison.

3. The authentication apparatus according to claim 2, wherein the at least one processor is further configured to execute the instructions to determine that the personal authentication has succeeded when the number of times of matching between the collation information and the authentication information is equal to or larger than a threshold value.

4. The authentication apparatus according to claim 3, wherein the threshold value is set in correspondence with the number of the registered collation information.

5. The authentication apparatus according to claim 3, wherein the threshold value is set in correspondence with a determination condition of the biometric authentication using the first biometric information.

6. The authentication apparatus according to claim 5, wherein the threshold value is set to be smaller as the determination condition of the biometric authentication using the first biometric information becomes stricter.

7. The authentication apparatus according to claim 1, wherein
the collation information includes order information indicating an authentication order, and
the at least one processor is further configured to execute the instructions to perform the comparison according to the order information.

8. (canceled)

9. An authentication method comprising:
acquiring authentication information that is second biometric information of a user who has succeeded in biometric authentication using first biometric information, and is second biometric information capable of being acquired by an instrument that has acquired the first biometric information;
comparing collation information registered in advance with the authentication information; and
performing personal authentication of the user on the basis of a result of the comparison.

10. A non-transitory computer-readable medium that stores a program causing a computer to execute:
acquisition processing of acquiring authentication information that is second biometric information of a user who has succeeded in biometric authentication using first biometric information, and is second biometric information capable of being acquired by an instrument that has acquired the first biometric information;
comparison processing of comparing collation information registered in advance with the authentication information; and
authentication processing of performing personal authentication of the user on the basis of a result of the comparison.
